(19) United States
(12) Patent Application Publication
(10) Pub. No.: US 2026/0050608 A1
(43) Pub. Date: Feb. 19, 2026

(54) Technologies for Data Integration Patterns and A Data Fabric

(71) Applicant: The PNC Financial Services Group, Inc., Pittsburgh, PA (US)

(72) Inventors: Jess Zacharias, Wexford, PA (US); Rajesh Kumar Saini, Mars, PA (US)

(21) Appl. No.: 19/299,413

(22) Filed: Aug. 14, 2025

Related U.S. Application Data
(60) Provisional application No. 63/683,724, filed on Aug. 16, 2024.

(51) Int. Cl. G06F 16/28

(52) U.S. Cl. CPC G06F 16/283

(57) ABSTRACT

Technologies for data integration patterns and a data fabric include a compute device with circuitry configured to obtain data from multiple sources. The circuitry may also be configured to coordinate ingestion of the obtained data into an ingestion framework of a data fabric and provide the ingested data from the ingestion framework to a meta model layer of the data fabric to produce metadata. Other embodiments are also described and claimed.

### RELATED APPLICATIONS

This application claims the benefit of U.S. Provisional Application No. 63/683,724 filed Aug. 16, 2024, for “Technologies for Data Integration Patterns and a Data Fabric,” which is hereby incorporated by reference in its entirety.

### BACKGROUND

Large institutions may manage a multitude of operations across disparate computer systems. Events associated with the various operations may occur at different rates or frequencies as a function of the type of operation. For some operations that typically require multiple days to complete, status information regarding the operations may be encoded in a defined format (e.g., structure) and processed in batches at regularly scheduled times (e.g., daily or weekly). However, with increasing digitalization, data associated with operations of the institution may be produced at more rapid rate and may take many different forms. As such, conventional systems architected to utilize data in a specific format and to read in the data for processing at regularly scheduled intervals may be unable to effectively capture, parse, and analyze the data produced in modern computerized operations.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for utilizing a data fabric to efficiently ingest and analyze data from multiple sources;

FIG. 2 is a simplified block diagram of at least one embodiment of a compute device of the system of FIG. 1;

FIGS. 3-7 are diagrams of components and functions associated with a data fabric that may be utilized by the system of FIG. 1;

FIGS. 8-9 are flowcharts of at least one embodiment of a method for orchestrating data ingestion and analysis operations with the data fabric that may be performed by the system of FIG. 1;

FIGS. 10-11 are flowcharts of at least one embodiment of a method for analyzing data with one or more models based on an unscheduled trigger that may be performed by the system of FIG. 1;

FIGS. 12-13 are flowcharts of at least one embodiment of a method for monitoring data utilization in the data fabric and adaptively modifying one or more pipelines to improve efficiency that may be performed by the system of FIG. 1; and

FIGS. 14-15 are flowcharts of at least one embodiment of a method for executing data ingestion operations that are defined based on configuration data that may be performed by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

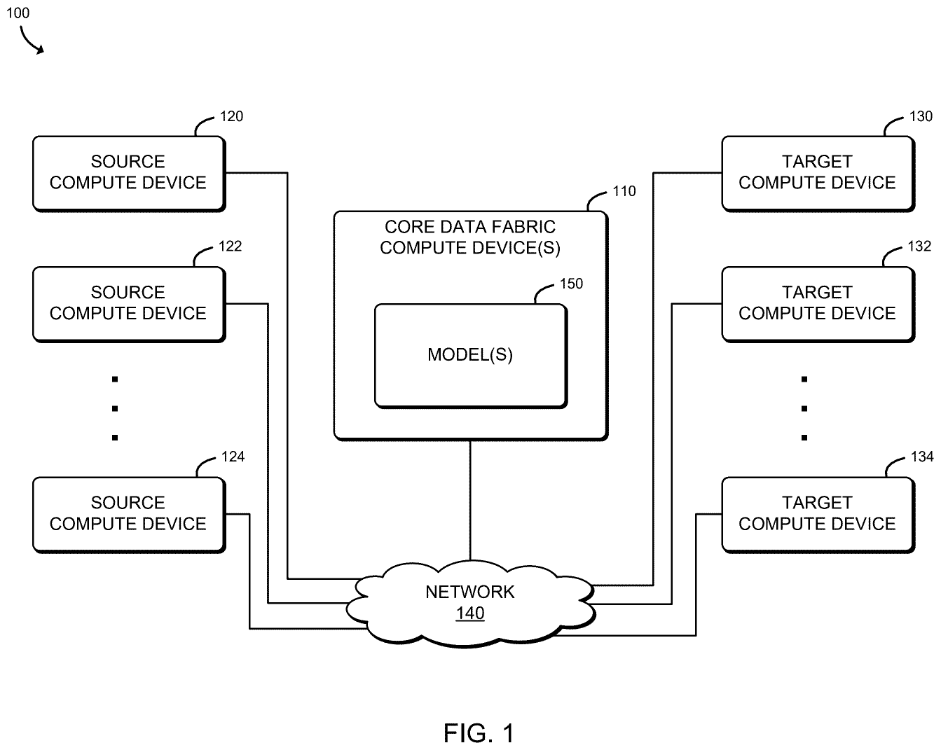

Referring now to FIG. 1, a system 100 for utilizing a data fabric to efficiently ingest and analyze data includes a set of one or more core data fabric compute devices 110, a set of source compute devices 120, 122, 124 and a set of target compute devices 130, 132, 134. In operation, the core data fabric compute devices 110 obtain data from the source compute devices 120, 122, 124 through an ingestion process in which the data may be reformatted or re-shaped to satisfy end uses of the data (e.g., for data analysis operations). Further, the core data fabric compute devices 110 perform analysis operations on the ingested data and provide results of the analysis to the target compute devices 130, 132, 134 on an as-requested basis. Unlike conventional systems, the core data fabric compute devices 110, as described in more detail herein, enable data having any of a number of formats (e.g., structured, unstructured, semi-structured) to be provided by the source compute devices 120, 122, 124 for analysis. Further, the core data fabric compute devices 110 enable the incoming data to be provided in scheduled batches or in one or more streams, thereby enabling real-time analysis of data (e.g., as underlying events or transactions associated with the data occur). Relatedly, the core data fabric compute devices 110 enable data to be analyzed on an as-requested basis (e.g., by one or more models 150 (e.g., algorithms, machine learning models, rules-based models, etc.)), such as through application programming interface calls, rather than performing data analysis only according to a defined schedule. As described in more detail herein, the core data fabric compute devices 110 may also enable data ingestion operations to be defined through configuration data (e.g., rather than computer code) and may monitor data utilization and adaptively reconfigure data pipelines to improve performance (e.g., enhance efficiency).

While a relatively small number of compute devices 110, 120, 122, 124, 130, 132, 134 are shown in FIG. 1 for simplicity and clarity, it should be understood that the number of compute devices, in practice, may range in the tens, hundreds, thousands, or more. Likewise, it should be understood that the compute devices 110, 120, 122, 124, 130, 132, 134 may be distributed differently or perform different roles than the configuration shown in FIG. 1. Further, though shown as separate compute devices 110, 120, 122, 124, 130, 132, 134 in some embodiments, the functionality of one or more of the compute devices 110, 120, 122, 124, 130, 132, 134 may be combined into fewer compute devices and/or distributed across more compute devices than those shown in FIG. 1.

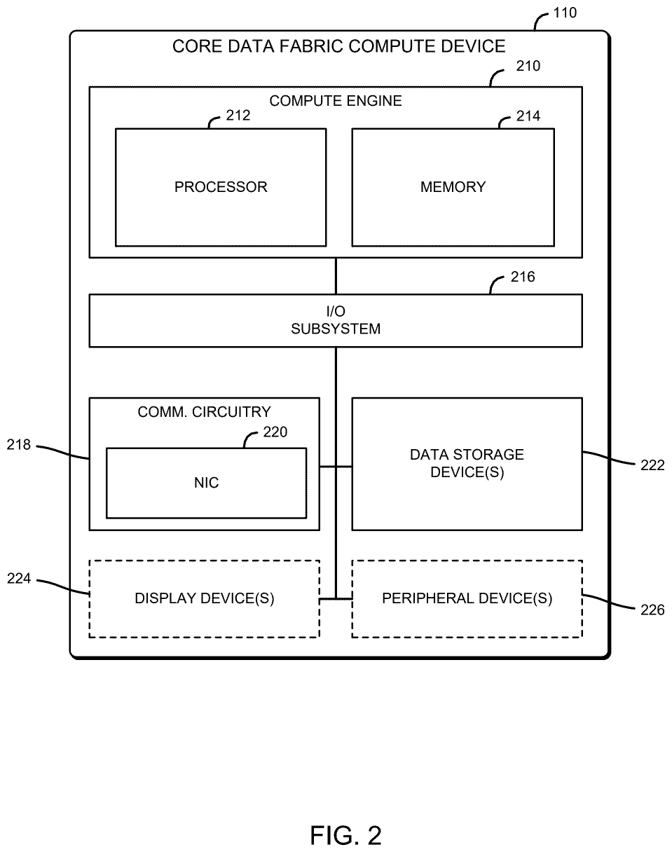

Referring now to FIG. 2, an illustrative embodiment of a core data fabric compute device 110 includes a compute engine 210, an input/output (I/O) subsystem 216, communication circuitry 218, and one or more data storage devices 222. In some embodiments, the core data fabric compute device 110 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the core data fabric compute device 110 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as models, configuration data, applications, libraries, and drivers.

The compute engine 210 is communicatively coupled to other components of the core data fabric compute device 110 via the I/O subsystem 216, which may be embodied as circuitry and/or components to facilitate input/output operations with the compute engine 210 (e.g., with the processor 212 and the main memory 214) and other components of the core data fabric compute device 110. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the core data fabric compute device 110, into the compute engine 210.

The communication circuitry 218 may be embodied as any communication circuit, device, or collection thereof, capable of enabling communications over a network between the core data fabric compute device 110 and another device (e.g., a compute device 120, 122, 124, 130, 132, 134, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the core data fabric compute device 110 to connect with another compute device (e.g., a compute device 120, 122, 124, 130, 132, 134, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the core data fabric compute device 110 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the core data fabric compute device 110 are housed in a single unit. However, in other embodiments, the components may be in separate housings, in separate racks of a data center, and/or spread across multiple data centers or other facilities. The compute devices 120, 122, 124, 130, 132, 134 may have components similar to those described in FIG. 2 with reference to the core data fabric compute device 110. The description of those components of the core data fabric compute device 110 is equally applicable to the description of components of the compute devices 120, 122, 124, 130, 132, 134. Further, it should be appreciated that any of the devices 110, 120, 122, 124, 130, 132, 134 may include other components, sub-components, and devices commonly found in a computing device, which are not discussed above in reference to the core data fabric compute device 110 and not discussed herein for clarity of the description.

In the illustrative embodiment, the compute devices 110, 120, 122, 124, 130, 132, 134, are in communication via a network 140, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

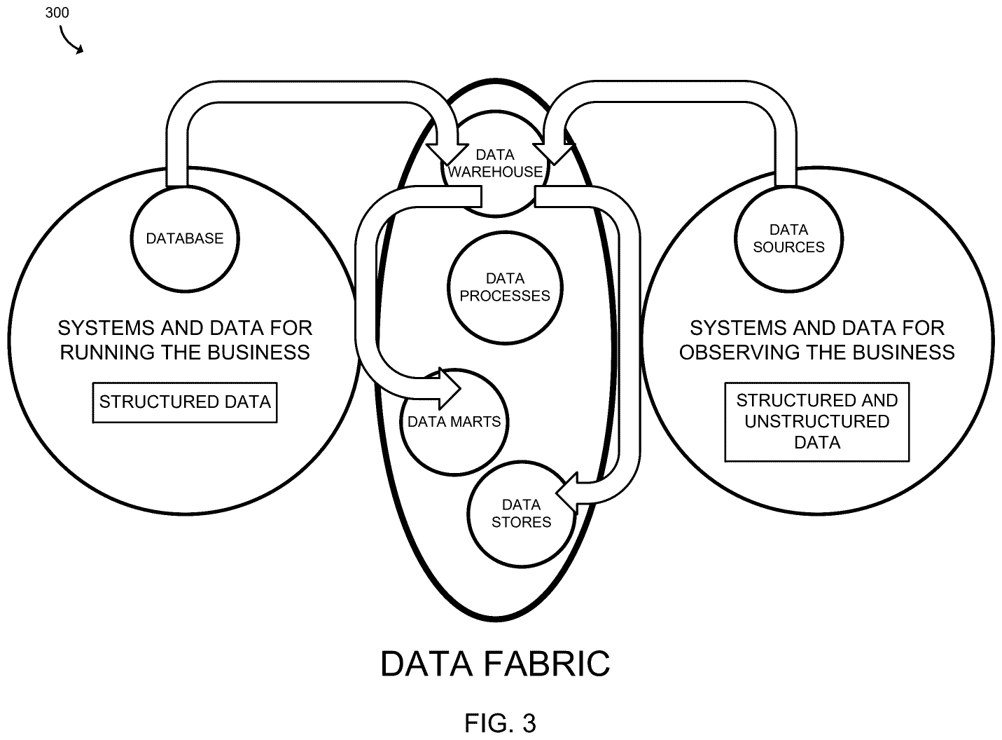

Referring now to FIG. 3, a data fabric 300 that may be implemented by the system 100, in the illustrative embodiment, is a scalable, distributed, composable architecture that connects data that exists across multiple tools and system to providing fit-for-use data to consumers with high agility and speed. The data fabric 300, in operation, removes data silos and enables a smooth transition to a data-driven enterprise. The data fabric 300 is architected around a set of guiding principles. One principle is that the data fabric 300 is use-case agnostic and is capable of supporting multiple data consumers and consumption patterns. Further, the data fabric 300 is a connected ecosystem that includes a diverse set of tools, technologies, and data repositories (e.g., data sets). Additionally, the data fabric 300 is able to connect data across internal and external sources, regardless of how the data is structured. Further, the data fabric 300 enables automation and accelerated value delivery. In addition, the data fabric 300 is based on a shared, consistent data model and business vocabulary. Moreover, the data fabric 300 is built for collaboration and data sharing, and enables case of data access. The data fabric 300 may also be continually updated to align with technology and business changes. In some embodiments, the data fabric 300 operates as a lending data fabric, providing an open data architecture that implements a closed-loop approach for analytics (e.g., events, data, decisions, actions), connecting data, analytics, and business teams to a shared data foundation. That is, the data fabric 300, in the illustrative embodiment, enables a business (e.g., an institution) to consume a connected holistic view of trusted data regardless of where the data exists, and generate actionable insights from that data. For business users, the data fabric 300 accelerates data self-service, leading to a shorter time to deliver business value through intuitive data discovery and case of data consumption. For technical users, the data fabric 300 supports a wide variety of framework-driven, standardized and accelerated approaches to source, shape, and ship data.

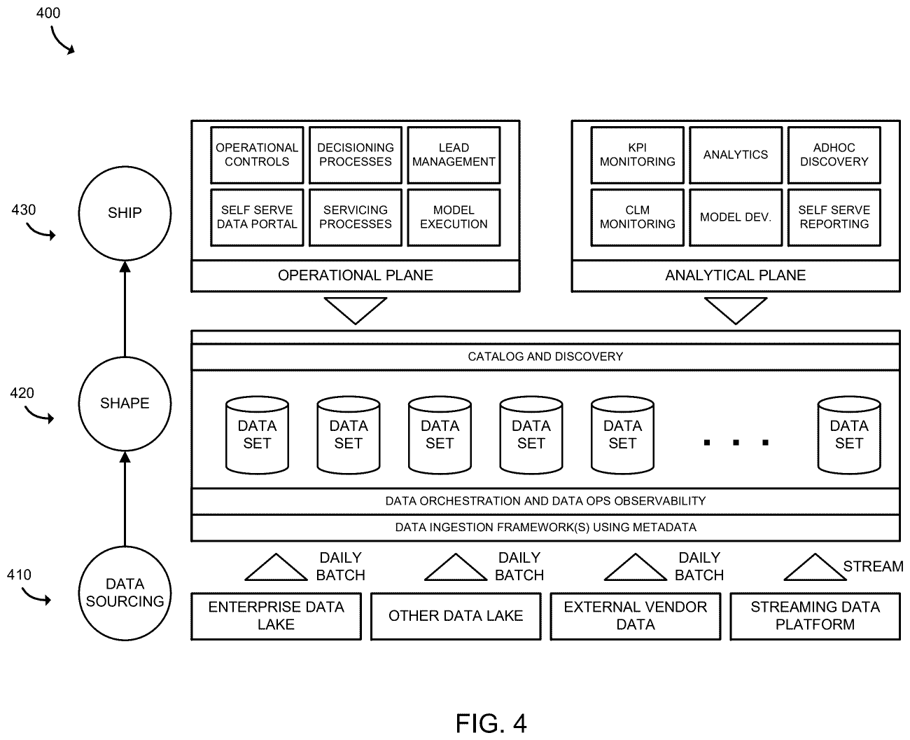

Referring now FIG. 4, an embodiment of an architecture 400 of the data fabric 300 includes three layers 410, 420, 430. A data sourcing layer 410 enables to a process of identifying and obtaining data from various sources (e.g., the source compute devices 120, 122, 124 of FIG. 1). The sources can include databases, data warehouses, application programming interfaces (APIs), files, streaming data, external system, and/or third-party providers. The data sourcing layer 410, in the illustrative embodiment, supports real time and batch data sourcing. A data shaping layer 420 involves transforming and storing the sourced data into a format and repository that is suitable for analysis or consumption. The data shaping layer 420, in the illustrative embodiment, provides polyglot (e.g., accommodating multiple data formats/structures) persistence (e.g., storage) and canonical models (e.g., a standard set of data to represent entities across different systems or data formats) to abstract data from the data sources. Further, a data shipping layer 430 enables provisioning of data to a consuming system or application. The data shipping layer 430 may include an operational plane 432 that provisions data (e.g., to target compute devices 130, 132, 134 of FIG. 1) to monitor technical operations and an analytics plane 434 that provisions data (e.g., to target compute devices 130, 132, 134) to monitor business related operations.

In at least some embodiments, a downstream system consumes data from the data fabric 300 with representational state transfer (e.g. REST) APIs built on a graph query language (e.g., GraphQL) technology. Further the data fabric 300, in some embodiments, may support a variety of platforms, including a retail lending analytics platform with an extract, transform, and load (ETL) framework. The data fabric 300, in the illustrative embodiment, also utilizes canonical data modeling. Regarding the data sourcing layer 410 of the architecture 400, data sourcing may involve determining data requirements, the appropriate sources to satisfy those requirements, and extracting the data from those sources. In the illustrative embodiment, the data fabric 300 uses an ingestion framework that supports horizontal scalability and high throughput by utilizing a unified analytics engine for large-scale data processing. Further, and as described in more detail herein, operations of the ingestion framework may be driven by configuration data, rather than code.

Regarding the data shaping layer 420, data shaping, in the illustrative embodiment, involves transforming and preparing sourced data (e.g., from the data sourcing layer 410) into a format that is suitable for analysis or consumption. The operation may include a multitude of functions, such as data cleaning, data integration, data normalization, data aggregation, data enrichment, and/or data filtering. In performing the functions, the data shaping layer 420 structures and organizes the data in a way that is consistent, reliable, and aligned with the analysis objectives. Further, in the illustrative embodiment, the data fabric 300 operates as a polyglot store for data. As such, the data fabric enables selection and leveraging of the most appropriate storage technology for each data type, taking into account factors such as size, performance requirements, access patterns, and cost considerations. Polyglot storage encompasses the utilization of multiple different storage technologies within the data fabric 300. The storage technologies (e.g., data sets) may include relational databases, NoSQL databases, columnar databases, and/or others. In at least some embodiments, the data fabric 300 includes a knowledge data store that utilizes graph data structures to store and analyze complex relationships across multiple data entities (e.g., for customer analytics, customer segmentation, and fraud detection). The graph data structures utilize nodes that are connected by edges (e.g., representing relationships). The nodes may include properties, each indicative of a set of data regarding the entity represented by the node. Further, the data set for the graph data structures may scale horizontally to accommodate increasing amounts of data.

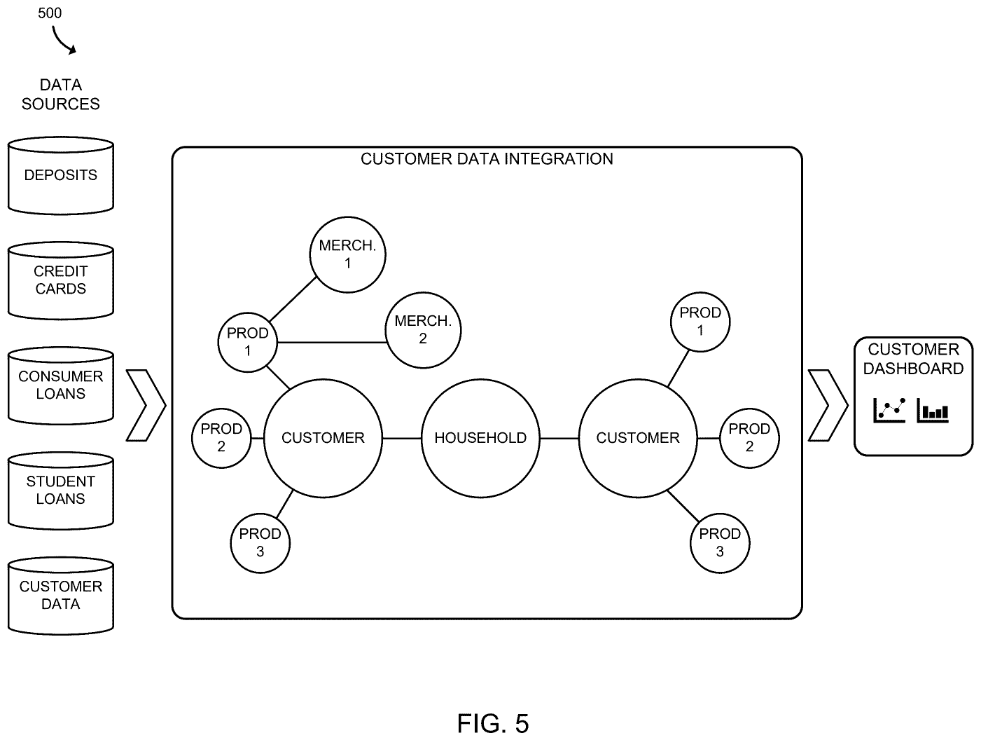

Referring now to FIG. 5, a graph data structure may be embodied as a knowledge graph 500. In the illustrative embodiment, the knowledge graph 500 connects data from disparate sources using relationships, including predictive relationships, to enable informed decisions. The knowledge graph 500 may be utilized for business use cases in areas such as customer analytics and customer segmentation. In the illustrative embodiment, the data fabric 300 may publish a catalog of graph models, queries, and ingestion patterns for different use case categories. Data samples across multiple data sources may be used to build a holistic view of each customer. In the illustrative embodiment, the model (e.g., the knowledge graph 500) may deliver insights on customer attributes such as household and spending behavior, including cross-product analysis of customer behavior. That is, the knowledge graph 500 may provide a view of all products held by a customer. Further, the knowledge graph 500 may enable merchant popularity to be tracked in real time, for tailoring offers and optimizing for wallet share. In addition, the knowledge graph 500 may enable identification of households and extended family based on complex relationships revealed by the knowledge graph 500. Further, the knowledge graph 500 may identify customers that are in the same building. In at least some embodiments, the knowledge graph 500 enables aggregation of utilization at the household level and the customer level. Further, the knowledge graph 500, in certain implementations, may enable identification of the most similar customers based on merchant spend. Additionally or alternatively, the knowledge graph 500, in some embodiments, may also provide a home equity line of credit (HELOC) and/or credit card basket for each household and customer.

As example uses, the knowledge graph 500 may enable identification of third party fraud patterns, address change patterns (e.g., change in address by an applicant within one week of applying for a loan), credit inquiry patterns, customer life events (e.g., through transaction and merchant analysis), customer segmentation by products (e.g., asset/liability), money movement, scoring and identification of high risk applications (e.g., for loans or other products). The knowledge graph 500 may also enable using geocoding to obtain latitude and longitude data to identify close proximity applications and authenticity of addresses, identification of first party fraud patterns, product recommendations, transaction monitoring, real-time customer ingestion, and prospecting.

The data fabric 300 may implement a stack for real-time streaming data analytics. That is, the data fabric 300 may enable real-time streaming from various sources, such as payments data and operational metadata. The data fabric 300 may parse and transform the streamlining data before storage. Further, the data fabric 300 may provide a user-friendly interface for searching, visualizing, and analyzing log data, enabling real-time monitoring, anomaly detection, and troubleshooting. In at least some embodiments, the data fabric 300 may utilize data sources that include data pertaining to accounting and servicing management of consumer installment loans and lines of credit, customer master data (e.g., address, name, etc.), financial statements, pricing information, history information, consumer credit cards, home equity data, business credit card data, business line of credit data, signature lines of credit, credit bureau data regarding customers, and collections and underwriting data. The stack of technologies utilized by the data fabric may include MongoDB, Oracle, Teradata, Hive, and Impala for data repositories, Neo4J graph database, graph data science and bloom graph visualization for graph technologies, Elasticsearch, Logstash, and Kibana, Kafka data streaming, Alation data catalog and discovery, GraphQL API, Java, Python, and PySpark. The data fabric 300 may create and serve data products through real-time consumption patterns (event streaming, real-time monitoring, etc.) and may persist data in repositories to support periodic and ad-hoc reporting and analytics consumption. The data fabric 300 may execute data pipelines on a periodic basis to populate those repositories. Further, the data fabric 300 may utilize data encryption and decryption mechanisms to move data to and from third party vendors.

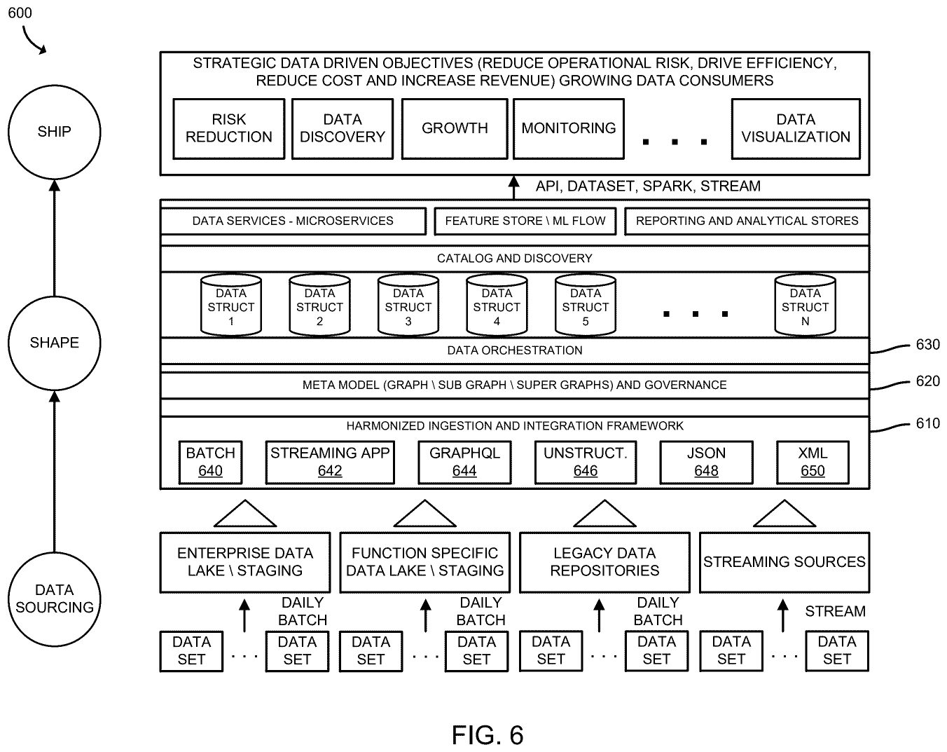

An embodiment of an architecture 600 of the data fabric 300 is shown in FIG. 6, illustrating additional features not shown in the architecture 400 of FIG. 4. In the illustrative embodiment, the architecture 600 enables data to be accessible to relevant users based on their unique workflows. The architecture 600 simplifies data access in an organization (e.g., institution) and facilitates self-service data consumption. Teams can utilize the architecture 600 to automate data discovery, governance, and consumption through end-to-end data management capabilities. Whether data engineers, data scientists, or business users, the data fabric architecture 600 delivers the data needed for each user's workflow. In at least some embodiments, and as described in more detail herein, the data fabric 300 may monitor repeated data usage scenarios and automate operations or modify data pipelines to increase the efficiency with which data is utilized and operated on in the data fabric 300. The data fabric 300 operates to provide a data catalog, data engineering, data governance, data preparation and orchestration, data integration, data persistence in polyglot storage, data analysis and modeling, data security, and graph models. With respect to the data catalog, the data fabric 300 classifies and inventories data assets and represents a data supply chain visually. A centralized repository may store metadata about the data, including data definitions, relationships, and lineage.

With respect to data engineering, the data fabric 300 may analyze and organize raw data, build data systems and pipelines, evaluate business needs and objectives, interpret trends and patterns for extraction, transformation, and loading, conduct complex data analysis and report on results, prepare data for prescriptive and predictive modeling, and build algorithms to ingest and persist data in polyglot stores. Regarding data governance, the data fabric 300 implements policies and processes for managing the use of data, including data access, retention, and deletion. For data preparation and orchestration (e.g., with a data orchestration layer 630), the data fabric 300 provides tools and technologies for processing and analyzing data, including big data platforms, data warehousing, and business intelligence tools. Additionally, the data fabric 300 may provide tools for visualizing data and communicating insights with dashboards, reports, and/or interactive visualizations. With regard to data integration, the data fabric 300, in the illustrative embodiment, includes a harmonized ingestion an integration framework 610, which may provide components 640, 642, 644, 646, 648, 650 (e.g., tools and computer-implemented methods) for integrating data from multiple sources, including databases, cloud services, and/or other systems. The data persistence layer provides a scalable and secure infrastructure for storing and managing data, including databases, data lakes, and cloud storage. Regarding data analysis and data modeling, the data fabric 300 may analyze and translate business needs into long-term solution data models, conceptual data models, and data flows. With respect to data security, the data fabric 300 may provide measures for protecting the confidentiality and privacy of data, including encryption, access controls, and data masking. Relative to graph models, the data fabric 300 may provide translation of a conceptual view of data to a logical model or graph, with a metal model and governance layer 620.

Data ingestion patterns for the data fabric 300 may include an initial operation of data ingestion, which may include prioritization and categorization of data. Subsequently, the data fabric 300 may perform a data collection operation, which involves transferring data to a staging layer. Afterwards, the data fabric 300 may perform validation, cleaning, and transformation (e.g., between formats or data structures) in a data processing operation. Next, the data fabric 300 may store the data using a polyglot storage in one or more of multiple data sets (e.g., Oracle, ELK, Mongo, Hive, etc.). In a data query operation, the data fabric 300 may derive data and perform advanced analytics on the data in the polyglot storage. Further, the data fabric 300 may perform a visualization operation to visually (e.g., in a user interface) present results of an analysis to a user (e.g., at a target compute device 130, 132, 134) of FIG. 1. The pattern of data ingestion (e.g., the process of importing data into the data fabric 300) can have a significant impact on the overall performance and scalability of the data fabric 300. Data ingestion patterns may include batch ingestion, real-time ingestion, event-driven ingestion, or hybrid ingestion. In batch ingestion, the data fabric 300 ingests data in relatively large quantities at set intervals (e.g., overnight). The pattern is well-suited to data that is generated in bulk and that is relatively static, such as data from financial systems or log files.

In real-time ingestion, the data fabric 300 ingests data as soon at the data is generated, without delay. The pattern is well-suited to data that is generated in high volumes and that changes frequently, such as sensor data, social media data, or data pertaining to high speed computerized transactions. In event-driven ingestions, data is ingested in response to a specific event, such as a change in data in another system. The pattern is well-suited to data pertaining to scenarios that would benefit from immediate processing and analysis, such as customer data or operational data. In hybrid ingestions, the data fabric 300 combines multiple ingestion patterns, such as batch and real-time ingestion. That pattern is suited to organization (e.g., institutions) that need to manage a mix of different types of data and use cases. The selection of a data ingestion pattern depends on the specific requirements for the data being ingested and the goals of the organization (e.g., institution). A well-designed data ingestion process is important for ensuring that data is correctly ingested and managed within the data fabric 300.

Regarding shaping of data, the data fabric 300, in the illustrative embodiment, utilizes a polyglot data store that enables the use of multiple data storage technologies, each adapted for a specific type of data or use case. As such, the data fabric 300 takes advantage of the strengths of different storage technologies to store different types of data in the most appropriate manner (e.g., to obtain high efficiency). For example, the data fabric 300 may utilize a relational database for structured data, a NoSQL database for unstructured data, and a data lake for big data. By using a combination of the storage technologies (e.g., data sets), the data fabric 300 may store and process data more efficiently, while also improving data accessibility and reliability. The use of a polyglot data store in the data fabric 300 is dependent on a data integration layer than can support the seamless flow of data between different data stores (e.g., data sets). To provide that functionality, the layer manages data consistency, data quality, and data security regardless of the underlying storage technology (e.g., data structures). The use of a polyglot data store enables the data fabric 300 to better manage data, increase data processing and storage capacity, and reduce costs associated with data management. Further, use of the polyglot data store improves the ability of the data fabric 300 to provide flexibility and scalability, and an ability to adapt to changing technical requirements and use cases.

With regard to the ship layer of the data fabric 300, the data fabric 300 provides data visualization (e.g., dashboards, reports, etc.). In doing so, the data fabric 300 may utilize a graph query language and runtime to access and manage data from multiple sources and connect different systems and applications. The graph query language and runtime may provide flexibility (e.g., allowing developers to specify exactly what data is needed for a particular query, reducing the amount of unnecessary data being transferred and processed, thereby increasing efficiency and performance). Further, the graph query language and runtime may provide improved productivity through a simplified syntax for querying data, thereby reducing the amount of code needed to access data and improving developer productivity. Additionally, the graph query language and runtime provides a single endpoint for accessing data, thereby streamlining the management of data quality and consistency over conventional systems. The use of a single endpoint also helps to simplify the process of integrating data from multiple sources. The graph query language and runtime, in the illustrative embodiment, is architected to work with web and mobile applications, providing fast and efficient access to data and reducing the amount of data that needs to be transmitted over the network (e.g., to obtain the same result, as compared to conventional systems).

Adding a new application or system in the data fabric 300 starts with the top most layer known as the ship layer. The catalog is served in this layer for applications to choose the APIs to source the data from the data fabric 300. The ship layer is exposed by the data fabric 300 for the new application/system. The new application will consume the data (integrating with the data fabric 300) through APIs from the ship layer, rather than reaching out to its existing multiple source systems or applications. In turn, the data fabric 300 defines source data stores and creates target data models into the polyglot stores of the data fabric 300. The data fabric 300 also defines business logic and rules to process the data coming from sources. Further the data fabric 300 maps the new attributes using the framework of data ingestion into the polyglot stores of the data fabric 300 from the sources. The data fabric 300 also analyzes and creates APIs with respective request and response structure (data models) required for the new application to be on-boarded into the data fabric 300. In addition, the data fabric 300 provides a graph model to define the business decisions based on the business rules. Further, the data fabric 300 performs derivation of the data ingested into the polyglot stores from different data sources. The data fabric 300 may also apply machine learning algorithms for creating a decision tree for the application. Additionally, the data fabric 300 may set an archival procedure and historical data availability for the new application.

The data fabric 300, in the illustrative embodiment, utilizes a canonical data model or meta model (e.g., at the meta model and governance layer 620), which is embodied as an established representation of data that is used to ensure consistency and accuracy across a data landscape. That is, the canonical data model (e.g., meta model) provides consistency, ensuring that data is consistently represented across different systems and applications. Consistency helps to improve data quality, reduces the risk of data duplication and errors, and simplifies integration of data from multiple sources. Further, the canonical data model provides data governance, establishing and enforcing standards, ensuring that data is properly managed and protected. In addition, the canonical data model provides improved data accessibility. That is, the common representation of data enables developers and data analysts to more easily access and work with data, reducing the time and effort needed to understand and use the data. In addition, the canonical data model enables improved data insights, by making it easier to combine data from different sources and to perform cross-functional analysis. Overall, having a canonical data model or meta model helps ensure that data is consistent, accessible, and properly managed, thereby accelerating digital transformation.

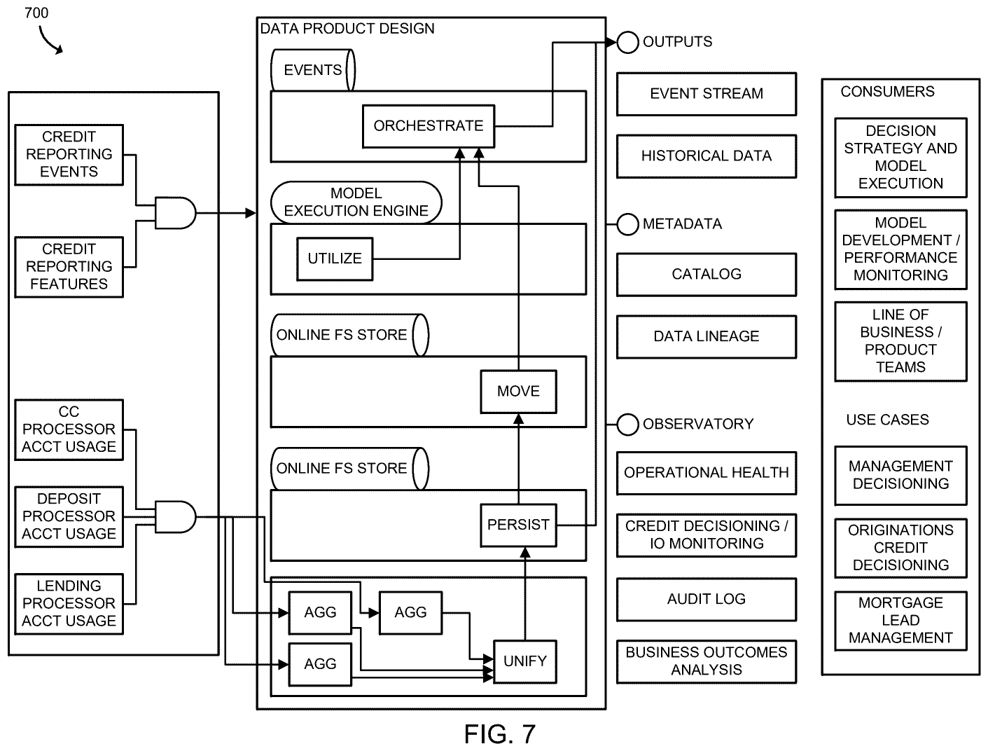

FIG. 7 shows a diagram of an embodiment of a real-time crediting decisioning enablement solution 700 that may be implemented with the data fabric 300. The solution 700 may utilize real time or near real time bureau, customer relationship, and account features using a service pattern. At the lowest layer, the solution 700 aggregates account counts at the customer level, aggregates default and overdrafts at the customer level, aggregates balances at the customer level, and unifies the aggregated features. At a higher layer, the solution 700 persists historical data for analytics and model development. Above that layer, the solution 700 moves data to a highly available online feature store. In the next layer, the solution 700 uses features to execute models and generate decision inputs. Above that layer, the solution 700 orchestrates events and feature input to generate streaming output.

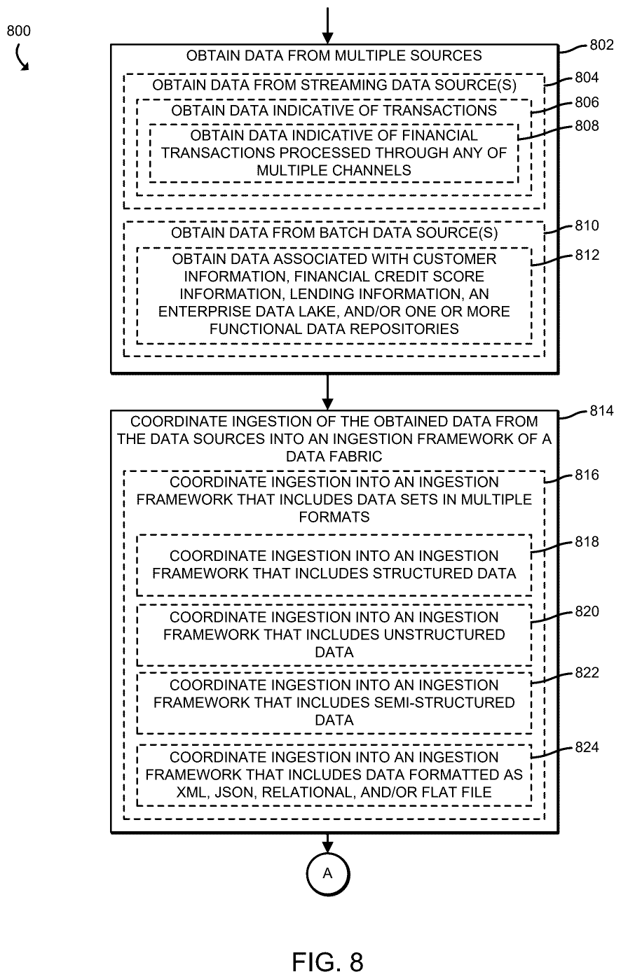

Referring now to FIG. 8, the system 100 (e.g., a core data fabric compute device 110) may perform a method 800 for orchestrating data ingestion and analysis operations. The method 800, in the illustrative embodiment, begins with block 802 in which the core data fabric compute device 110 obtains data from multiple sources (e.g., the source compute devices 120, 122, 124). In doing so, and as indicated in block 804, the core data fabric compute device 110 may obtain data from one or more streaming data sources. In obtaining data from one or more streaming data sources, the core data fabric compute device 110 may obtain data indicative of transactions, as indicated in block 806. For example, and as indicated in block 808, the core data fabric compute device 110 may obtain data indicative of financial transactions processed through any of multiple channels (e.g., credit card payments, automated clearing house (ACH) payments, digital payments network transactions, etc.). As indicated in block 810, the core data fabric compute device 110 may obtain data from a batch data source. In doing so, the core data fabric compute device 110 may obtain data associated with customer information, financial credit score information, lending information, an enterprise data lake, and/or one or more functional data repositories, as indicated in block 812.

Continuing the method 800, in block 814, the core data fabric compute device 110, in the illustrative embodiment, coordinates ingestion of the obtained data from the data sources (e.g., from the source compute devices 120, 122, 124) into an ingestion framework of a data fabric (e.g., the data fabric 300). In doing so, and as indicated in block 816, the core data fabric compute device 110 may coordinate ingestion into an ingestion framework that includes data sets in multiple formats (e.g., a polyglot data store). As indicated in block 818, the core data fabric compute device 110 may coordinate ingestion into an ingestion framework that includes structured data (e.g., in a defined format, such as in the form of rows and columns). The core data fabric compute device 110 may coordinate ingestion into an ingestion framework that includes unstructured data (e.g., data that does not have a defined format, such as images, sensor data, log files, etc.), as indicated in block 820. The core data fabric compute device 110 may coordinate ingestion into an ingestion framework that includes semi-structured data (e.g., data that is not in a standard table format of rows and columns but contains markers to separate semantic elements and to enforce hierarchies of records and fields within the data), as indicated in block 822. In some embodiments, the core data fabric compute device 110 may coordinate ingestion into an ingestion framework that includes data formatted as extensible markup language (XML) data, JavaScript object notation (JSON) data, relational data, and/or flat file data (e.g., data stored in a simple file, such as a plain text file, that has no structure for indexing or recognizing relationships), as indicated in block 824.

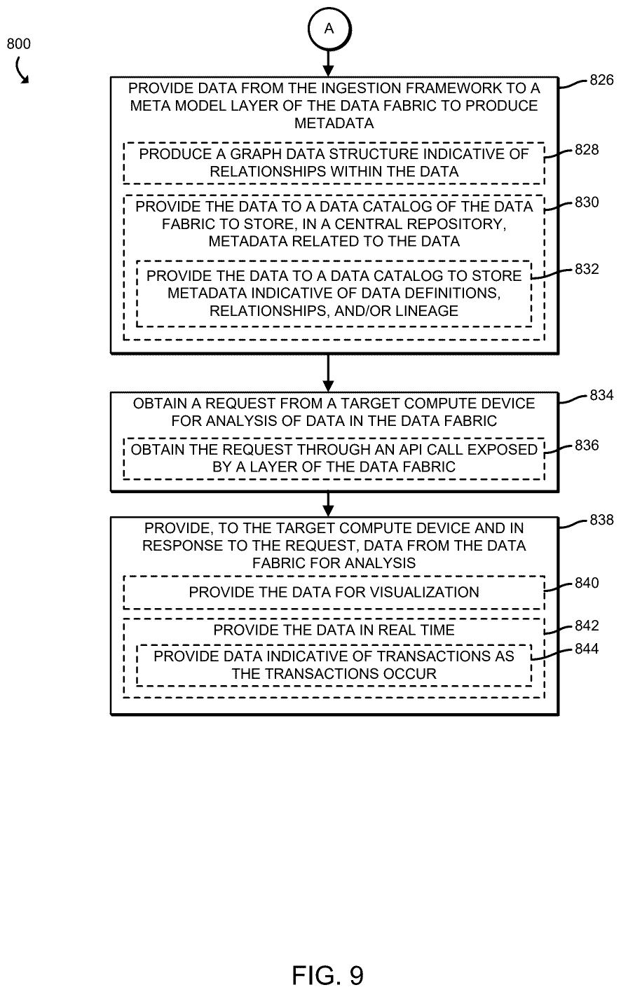

Referring now to FIG. 9, the method 800 continues in block 826, in which the core data fabric compute device 110 provides data from the ingestion framework to a meta model layer (e.g., the metal model of the architecture 600 of FIG. 6, which is similar to a canonical data model, as described above) of the data fabric 300 to produce metadata. In doing so, the core data fabric compute device 110 may produce a graph data structure indicative of relationships within the data, as indicated in block 828. The core data fabric compute device 110 may provide the data to a data catalog (e.g., the data catalog show in the architecture 600 of FIG. 6) of the data fabric to store, in a central repository (e.g., the data catalog operates as a central repository), metadata related to the data, as indicated in block 830. In doing so, and as indicated in block 832, the core data fabric compute device 110 may provide the data to a data catalog to store metadata indicative of data definitions, relationships among data elements, and/or lineage (e.g., information indicative of how data has moved through the system 100 over time, including the origin of the data, the destination of the data, and transformations that have been performed on the data).

In block 834, the core data fabric compute device 110 may obtain a request from a target compute device (e.g., a target compute device 130, 132, 134) for analysis of data in the data fabric. As indicated in block 836, the core data fabric compute device 110 may obtain the request through an application programming interface call that is exposed by a layer of the data fabric, such as the APIs exposed between the shape and ship layers of the architecture 600 of FIG. 6. In block 838, the core data fabric compute device 110 may provide, to the target compute device 130, 132, 134, and in response to the request, data (e.g., the requested data) from the data fabric for analysis. In doing so, and as indicated in block 840, the core data fabric compute device 110 may provide the data for use in visualization (e.g., in a user interface presented on the target compute device 130, 132, 134). In some embodiments, the core data fabric compute device 110 may provide the data in real time, as indicated in block 842. In doing so, the core data fabric compute device 110 may provide data indicative of transactions as the transactions occur, as indicated in block 844 (e.g., to enable real time monitoring).

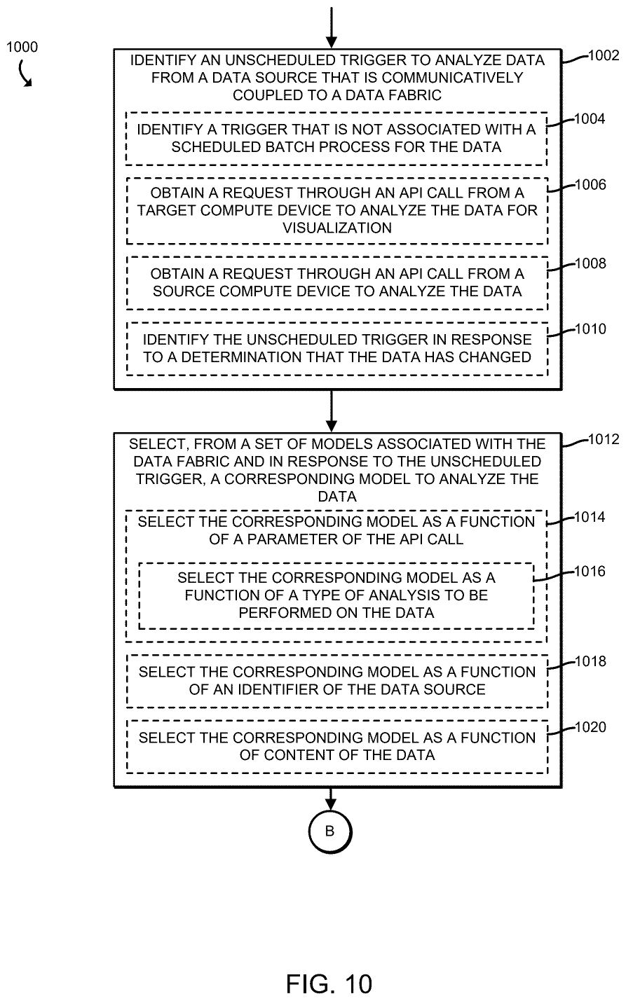

Referring now to FIG. 10, the system 100 (e.g., a core data fabric compute device 110) may perform a method 1000 for analyzing data with one or more models based on an unscheduled trigger. In the illustrative embodiment, the method 1000 begins with block 1002 in which the core data fabric compute device 110 identifies an unscheduled trigger to analyze data from a data source (e.g., a source compute device 120, 122, 124) that is communicatively coupled to a data fabric (e.g., the data fabric 300 implemented, at least in part, by the core data fabric compute device 110). In doing so, and as indicated in block 1004, the core data fabric compute device 110 may identify a trigger that is not associated with a scheduled batch process for the data. As indicated in block 1006, the core data fabric compute device 110 may obtain a request through an application programming interface (API) call from a target compute device 130, 132, 134 to analyze the data (e.g., for visualization). In some embodiments, the core data fabric compute device 110 may obtain a request through an API call from a source compute device 120, 122, 124 (e.g., from which the data was obtained) to analyze the data, as indicated in block 1008. In some embodiments, the core data fabric compute device 110 may identify the presence of the unscheduled trigger in response to a determination that the data has changed (e.g., the determination that the data has changed may be the trigger), as indicated in block 1010.

Continuing the method 1000, the core data fabric compute device 110 may select, from a set of models (e.g., the models 150 of FIG. 1) associated with the data fabric and in response to the unscheduled trigger, a corresponding model to analyze the data, as indicated in block 1012. As indicated in block 1014, the core data fabric compute device 110 may select the corresponding model as a function of a parameter of the API call (e.g., an argument passed in with the API call, such as a string or numeric value mapped to a corresponding model). As indicated in block 1016, the core data fabric compute device 110 may select the corresponding model as a function of a type of analysis to be performed on the data. For example, the API call may include a parameter that identifies the type of analysis to be performed and the core data fabric compute device 110 may reference a table or other data structure (e.g., in memory 214) that maps analysis types to identifiers of models. As indicated in block 1018, the core data fabric compute device 110 may select the corresponding model as a function of an identifier of the data source. For example, the core data fabric compute device 110 may reference a data structure (e.g., in memory 214) that associates data sources with models that have been defined as being appropriate (e.g., providing the expected type of analysis) for the type of data provided by the corresponding data source. As indicated in block 1020, the core data fabric compute device 110 may select the corresponding model as a function of content of the data. That is, the core data fabric compute device 110 may determine the type of the data based on an analysis keywords in the data or another analysis that identifies the type of content, and may reference a data structure (e.g., in memory 214) that associates types of content with corresponding models.

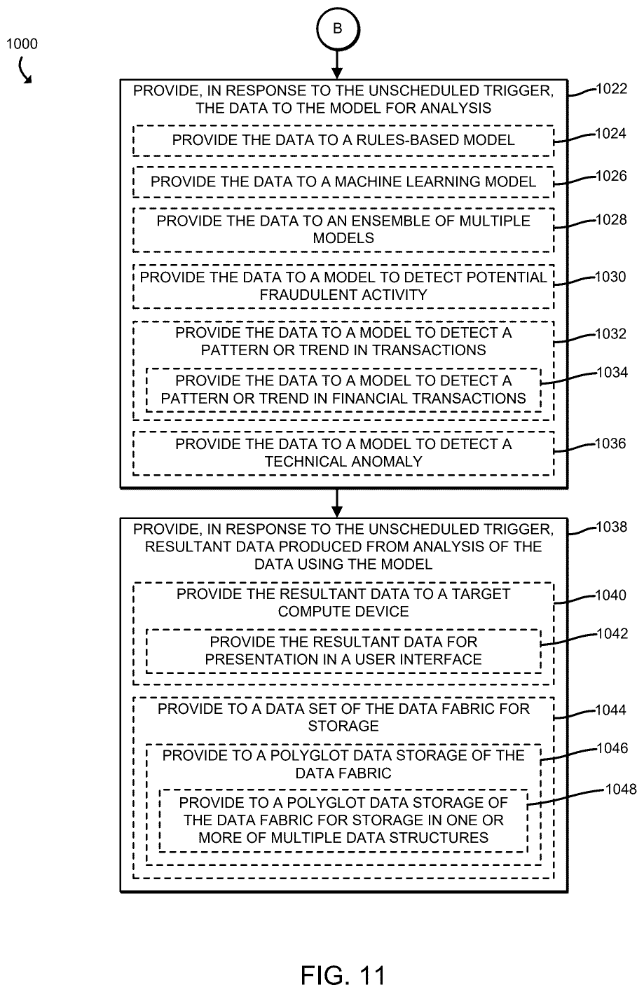

Referring now to FIG. 11, continuing the method 1000, the core data fabric compute device 110 provides, in response to the unscheduled trigger, the data to the model for analysis, as indicated in block 1022. In doing so, the core data fabric compute device 110 may provide the data to a rules-based model (e.g., a model that follows a set of defined rules, such as in a decision tree), as indicated in block 1024. Additionally or alternatively, the core data fabric compute device 110 may provide the data to a machine learning model (e.g., a neural network, a gradient boosted model, etc.), as indicated in block 1026. The core data fabric compute device 110 may provide the data to an ensemble (e.g., a combination) of multiple models (e.g., a combination of weak learner models that, together, operate as a strong learner, a combination of rules based models and neural network models, etc.), as indicated in block 1028. The core data fabric compute device 110 may provide the data to a model to detect potential fraudulent activity, as indicated in block 1030. As indicated in block 1032, the core data fabric compute device 110 may provide the data to a model to detect a pattern or trend in transactions. In doing so, the core data fabric compute device 110 may provide the data to a model to detect a pattern or trend in financial transactions, as indicated in block 1034. The core data fabric compute device 110, in some embodiments, may provide the data to a model to detect a technical an anomaly (e.g., indicating slow transaction processing times in a geographic region, indicating errors in log files, etc.), as indicated in block 1036.

Continuing the method 1000, the core data fabric compute device 110 may provide, in response to the unscheduled trigger, resultant data (e.g., indicative of a result) produced from analysis of the data using the model, as indicated in block 1038. In doing so, and as indicated in block 1040, the core data fabric compute device 110 may provide the resultant data to a target compute device (e.g., a target compute device 130, 132, 134 of FIG. 1). For example, and as indicated in block 1042, the core data fabric compute device 110 may provide the resultant data for presentation in a user interface (e.g., a web-based interface, an interface in a mobile application, etc. that visually presents the resultant data). As indicated in block 1044, the core data fabric compute device 110 may provide the resultant data to a data set (e.g., a database) of the data fabric for storage. In doing so, and as indicated in block 1046, the core data fabric compute device 110 may provide the resultant data to a polyglot data storage of the data fabric. For example, and as indicated in block 1048, the core data fabric compute device 110 may provide the resultant data to a polyglot data storage of the data fabric for storage in one or more of multiple data structures (e.g., a relational database, a flat file database, a graph database, etc.).

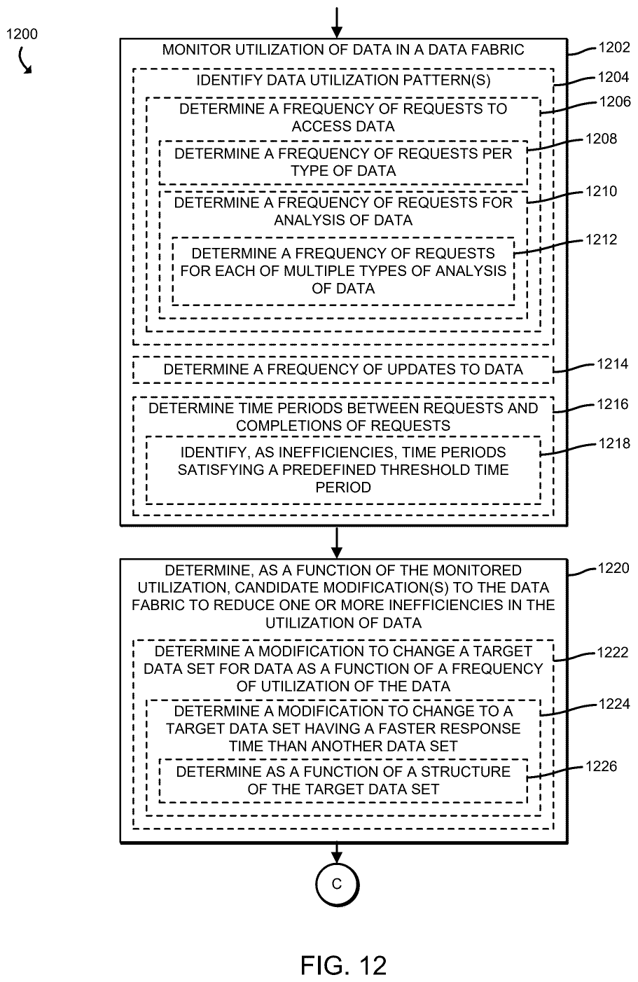

Referring now to FIG. 12, the system 100 (e.g., a core data fabric compute device 110) may perform a method 1200 for monitoring data utilization and adaptively modifying one or more data pipelines to improve efficiency. The method 1200, in the illustrative embodiment, begins in block 1202, in which the core data fabric compute device 110 monitors utilization of data in a data fabric (e.g., the data fabric 300). In doing so, and as indicated in block 1204, the core data fabric compute device 110 may identify one or more data utilization patterns. For example, and as indicated in block 1206, the core data fabric compute device 110 may determine a frequency of requests (e.g., from the target compute devices 130, 132, 134) to access data. In block 1208, the core data fabric compute device 110 may determine a frequency of requests per type of data (e.g., a frequency of requests for customer data, a frequency of requests for credit card transaction data, a frequency of requests for log data, etc.). As indicated in block 1210, the core data fabric compute device 110 may determine a frequency of requests for analysis of data. In doing so, and as indicated in block 1212, the core data fabric compute device 110 may determine a frequency of requests for each of multiple types of analysis of the data (e.g., trend analysis, outlier analysis, pattern analysis, analysis of data over each of multiple time periods, analysis of data (e.g., transaction data) associated with one geographic region compared to data of the same type associated with a different geographic region, etc.). In monitoring utilization of the data, the core data fabric compute device 110 may determine a frequency of updates to the data, as indicated in block 1214. Further, and as indicated in block 1216, the core data fabric compute device 110 may determine time periods between requests (e.g., to provide data, to analyze data, etc.) and completions of the requests (e.g., providing the requested data or performing the requested analysis). Further, the core data fabric compute device 110 may identify, as inefficiencies, time periods that satisfy a predefined threshold time period (e.g., an upper limit defined as acceptable for efficiency), as indicated in block 1218.

Subsequently, and as indicated in block 1220, the core data fabric compute device 110 may determine, as a function of the monitored utilization, one or more candidate modifications to the data fabric 300 to reduce one or more inefficiencies (e.g., identified in block 1218) in the utilization of the data. In doing so, and as indicated in block 1222, the core data fabric compute device 110 may determine a modification to change a target data set for data (e.g., where the data will be stored) as a function of a frequency of utilization of the data. As indicated in block 1224, the core data fabric compute device 110 may determine a modification to change from a present target data set to a different target data set that has a faster response time than the present target data set (e.g., based on measured response times from each of the data sets). As indicated in block 1226, the core data fabric compute device 110 may determine the modification to a different target data set as a function of the structure of the target data sets (e.g., from a relational data set to a flat file data set that is known to provide faster response times at the expense of less complex queries).

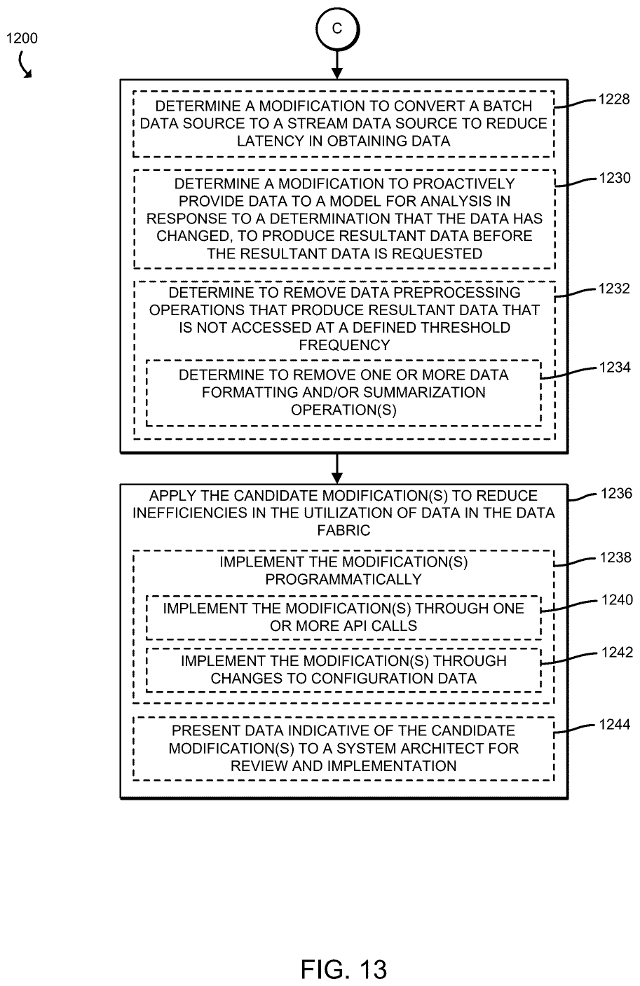

Referring now to FIG. 13, continuing the method 1200, the core data fabric compute device 110 may determine a modification to convert a batch data source (e.g., that provides data on a scheduled, periodic basis) to a stream data source to reduce latency in obtaining the data, as indicated in block 1228. Additionally or alternatively, the core data fabric compute device 110 may determine a modification to proactively provide data to a model for analysis in response to a determination that the data has changed, to produce resultant data (e.g., produced through analysis of the data by the model) before the resultant data is requested (e.g., by a target compute device 130, 132, 134), as indicated in block 1230. That is, in some embodiments, the core data fabric compute device 110 may determine that resultant data from a particular model based on a particular type of input data is requested (e.g., by a target compute device 130, 132, 134) at a frequency that satisfies a threshold frequency and that the response time for providing the requested data is greater than a defined upper limit. As such, through the modification, the model will produce the resultant data as soon as the new (e.g., changed) data is available, rather than waiting for the target compute device 130, 132, 134 to request the resultant data. As indicated in block 1232, the core data fabric compute device 110 may determine a modification to remove (e.g., from a pipeline) one or more data preprocessing operations (e.g., data shaping operations) that produce resultant data that is not accessed at a defined threshold frequency (e.g., not accessed frequently enough to justify the computational resources to perform the preprocessing operations). In doing so, and as indicated in block 1234, the core data fabric compute device 110 may determine to remove one or more data formatting or summarization operations.

Afterwards, and as indicated in block 1236, the core data fabric compute device 110 may apply the one or more candidate modifications to reduce inefficiencies in the utilization of data in the data fabric 300. In doing so, and as indicated in block 1238, the core data fabric compute device 110 may implement the one or more modifications programmatically. As indicated in block 1240, the core data fabric compute device 110 may implement the one or more modifications through one or more application programming interface calls (e.g., to a corresponding component of the architecture). Additionally or alternatively, the core data fabric compute device 110 may implement the one or more modifications through changes to configuration data, as indicated in block 1242. That is, in at least some embodiments, the operations of the data fabric, such as data ingestion operations, may be defined in configuration data rather than source code or object code. As indicated in block 1244, in some embodiments, the core data fabric compute device 110 may present (e.g., in a user interface) data indicative of the candidate modification(s) to a system architect for review and implementation, as indicated in block 1244.

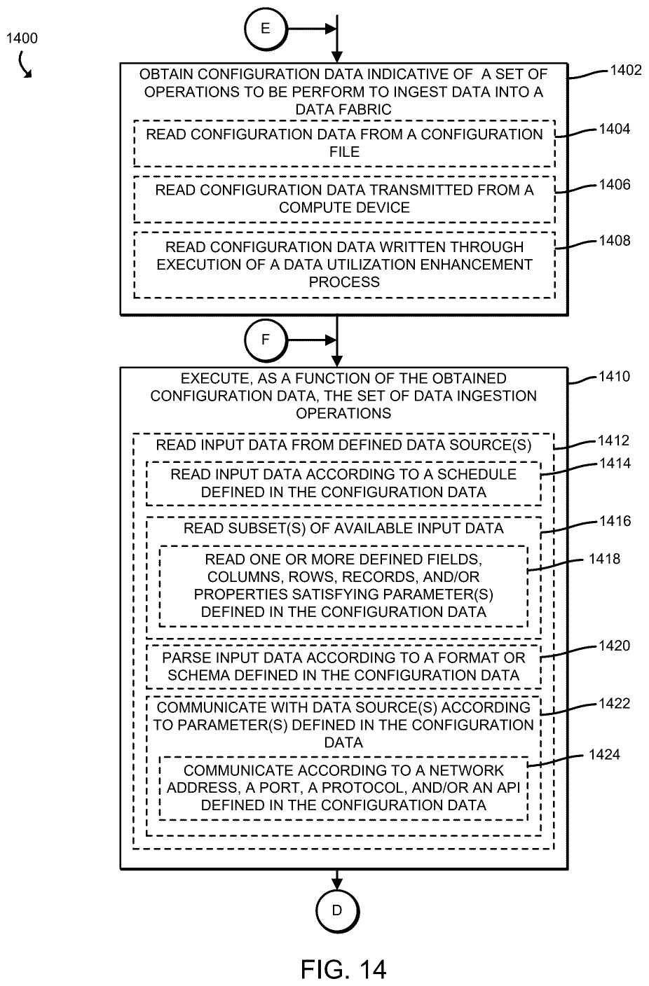

Referring now to FIG. 14, the system 100 (e.g., a core data fabric compute device 110) may perform a method 1400 for executing data ingestion operations that are defined based on configuration data. In the illustrative embodiment, the method 1400 begins with block 1402, in which the core data fabric compute device 110 obtains configuration data indicative of a set of operations to be performed to ingest data into a data fabric (e.g., the data fabric 300). In doing so, and as indicated in block 1404, the core data fabric compute device 110 may read configuration data from a file. Additionally or alternatively, the core data fabric compute device 110 may read configuration data transmitted from a compute device (e.g., another core data fabric compute device 110, or a compute device 120, 122, 124, 130, 132, 134), as indicated in block 1406. In some embodiments, the core data fabric compute device 110 may read configuration data that was written through execution of a data utilization enhancement process (e.g., configuration data in block 1242 of the method 1200), as indicated in block 1408.

Continuing the method 1400, the core data fabric compute device 110 may execute, as a function of (e.g., based on) the obtained configuration data, the set of data ingestion operations, as indicated in block 1410. In doing so, and as indicated in block 1412, the core data fabric compute device 110 may read input data from one or more defined data sources (e.g., as defined in the configuration data). For example, and as indicated in block 1414, the core data fabric compute device 110 may read input data according to a schedule defined in the configuration data. In block 1416, the core data fabric compute device 110 may read one or more subsets of available input data, as defined in the configuration data. In doing so, and as indicated in block 1418, the core data fabric compute device 110 may read one or more fields, columns, rows, records, and/or properties (e.g., from the available input data) that satisfy one or more parameters (e.g., only read records pertaining to a given time frame as indicated in a time stamp, only read specifically named fields, properties, etc.) defined in the configuration data. As indicated in block 1420, the core data fabric compute device 110 may parse input data according to a format or schema defined in the configuration data. The core data fabric compute device 110 may communicate with one or more data sources (e.g., source compute devices 120, 122, 124) according to one or more parameters defined in the configuration data, as indicated in block 1422. In doing so, and as indicated in block 1424, the core data fabric compute device 110 may communicate according to a network address, a port, a protocol, and/or an application programming interface defined in the configuration data.

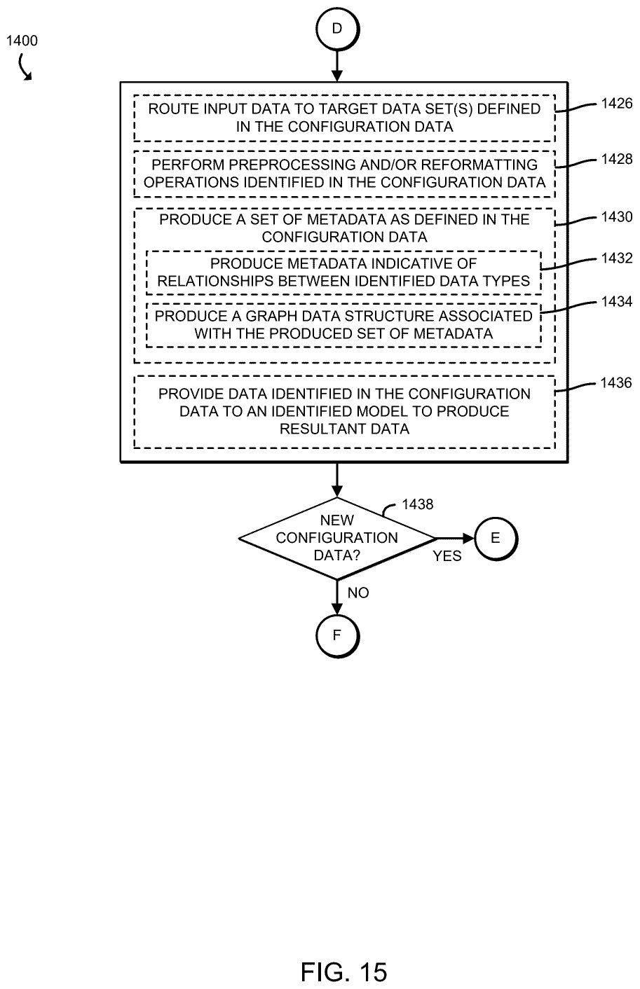

The method 1400 may continue in FIG. 15, in which the core data fabric compute device 110 may route input data to one or more target data sets (e.g., databases of the polyglot data store) defined in the configuration data, as indicated in block 1426. Additionally or alternatively, the core data fabric compute device 110 may perform preprocessing and/or reformatting operations identified in the configuration data, as indicated in block 1428. In some embodiments, the core data fabric compute device 110 may produce a set of metadata as defined in the configuration data, as indicated in block 1430. In doing so, the core data fabric compute device 110 may produce metadata indicative of relationships between identified data types or data elements in the input data, as indicated in block 1432. The core data fabric compute device 110 may further produce a graph data structure associated with the produced set of metadata (e.g., in which nodes represent data elements, properties of the nodes represent data associated with each data element, and edges connecting the nodes represent relationships), as indicated in block 1434. As indicated in block 1436, the core data fabric compute device 110 may provide data identified (e.g., by type, by the data source, etc.) in the configuration data to an identified model to produce resultant data (e.g., before that resultant data is requested by a target compute device 130, 132, 134).

In block 1438, the core data fabric compute device 110 determines whether new configuration data is available (e.g., by monitoring a location where configuration data is written, by listening for a request from another compute device to transmit new configuration data, etc.). In response to a determination that new configuration data is available, the method 1400 loops back to block 1402 to obtain the new configuration data. Otherwise, the method 1400 loops back to block 1410 to potentially execute data ingestion operations again (e.g., on an as requested basis, according to a schedule, etc.) based on the already obtained configuration data.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### Examples

Illustrative examples of the technologies disclosed herein are provided below. An embodiment of the technologies may include any one or more, and any combination of, the examples described below.

Example 1 includes a compute device comprising circuitry configured to obtain data from multiple sources; coordinate ingestion of the obtained data into an ingestion framework of a data fabric; and provide the ingested data from the ingestion framework to a meta model layer of the data fabric to produce metadata.

Example 2 includes the subject matter of Example 1, and wherein to obtain data from multiple sources comprises to obtain data from one or more streaming data sources.

Example 3 includes the subject matter of any of Examples 1 and 2, and wherein to obtain data from one or more streaming data sources comprises to obtain data indicative of transactions.

Example 4 includes the subject matter of any of Examples 1-3, and wherein to obtain data indicative of transactions comprises to obtain data indicative of financial transactions processed through one or more of multiple channels.

Example 5 includes the subject matter of any of Examples 1-4, and wherein to obtain data from multiple sources comprises to obtain data from one or more batch data sources.

Example 6 includes the subject matter of any of Examples 1-5, and wherein to obtain data from one or more batch data sources comprises to obtain data associated with customer information, financial credit score information, lending information, a data lake, or one or more functional data repositories.

Example 7 includes the subject matter of any of Examples 1-6, and wherein to coordinate ingestion comprises to coordinate ingestion into an ingestion framework that includes data sets in multiple formats.

Example 8 includes the subject matter of any of Examples 1-7, and wherein to coordinate ingestion into an ingestion framework that includes data sets in multiple formats comprises to coordinate ingestion into an ingestion framework that includes structured data.

Example 9 includes the subject matter of any of Examples 1-8, and wherein to coordinate ingestion into an ingestion framework that includes data sets in multiple formats comprises to coordinate ingestion into an ingestion framework that includes unstructured data.

Example 10 includes the subject matter of any of Examples 1-9, and wherein to coordinate ingestion into an ingestion framework that includes data sets in multiple formats comprises to coordinate ingestion into an ingestion framework that includes semi-structured data.

Example 11 includes the subject matter of any of Examples 1-10, and wherein to coordinate ingestion into an ingestion framework that includes data sets in multiple formats comprises to coordinate ingestion into an ingestion framework that includes data formatted as one or more of extensible markup language, JavaScript object notation, a relational database or a flat file database.

Example 12 includes the subject matter of any of Examples 1-11, and wherein to provide data from the ingestion framework to a meta model layer of the data fabric to produce metadata comprises to produce a graph data structure indicative of relationships within the data.

Example 13 includes the subject matter of any of Examples 1-12, and wherein to provide data from the ingestion framework to a meta model layer of the data fabric to produce metadata comprises to provide the data to a data catalog of the data fabric to store, in a central repository, metadata related to the data.

Example 14 includes the subject matter of any of Examples 1-13, and wherein to provide the data to a data catalog to store metadata related to the data comprises to provide the data to a data catalog to store metadata indicative of one or more of data definitions, relationships, or lineage.

Example 15 includes the subject matter of any of Examples 1-14, and wherein the circuitry is further configured to obtain a request from a target compute device for analysis of data in the data fabric; and provide, to the target compute device and in response to the request, data from the data fabric for analysis.

Example 16 includes the subject matter of any of Examples 1-15, and wherein to obtain a request from a target compute device for analysis comprises to obtain the request through an application programming interface call exposed by a layer of the data fabric.

Example 17 includes the subject matter of any of Examples 1-16, and wherein to provide, to the target compute device, data from the data fabric for analysis comprises to provide the data for visualization.

Example 18 includes the subject matter of any of Examples 1-17, and wherein to provide, to the target compute device, data from the data fabric for analysis comprises to provide the data in real time.

Example 19 includes the subject matter of any of Examples 1-18, and wherein to provide, to the target compute device, data from the data fabric for analysis comprises to provide data indicative of transactions as the transactions occur.

Example 20 includes a method comprising obtaining, by a compute device, data from multiple sources; coordinating, by the compute device, ingestion of the obtained data into an ingestion framework of a data fabric; and providing, by the compute device, the ingested data from the ingestion framework to a meta model layer of the data fabric to produce metadata.

Example 21 includes the subject matter of Example 20, and wherein obtaining data from multiple sources comprises obtaining data from one or more streaming data sources.

Example 22 includes the subject matter of any of Examples 20 and 21, and wherein obtaining data from one or more streaming data sources comprises obtaining data indicative of transactions.

Example 23 includes the subject matter of any of Examples 20-22, and wherein obtaining data indicative of transactions comprises obtaining data indicative of financial transactions processed through one or more of multiple channels.

Example 24 includes the subject matter of any of Examples 20-23, and wherein obtaining data from multiple sources comprises obtaining data from one or more batch data sources.

Example 25 includes the subject matter of any of Examples 20-24, and wherein obtaining data from one or more batch data sources comprises obtaining data associated with customer information, financial credit score information, lending information, a data lake, or one or more functional data repositories.

Example 26 includes the subject matter of any of Examples 20-25, and wherein coordinating ingestion comprises coordinating ingestion into an ingestion framework that includes data sets in multiple formats.

Example 27 includes the subject matter of any of Examples 20-26, and wherein coordinating ingestion into an ingestion framework that includes data sets in multiple formats comprises coordinating ingestion into an ingestion framework that includes structured data.

Example 28 includes the subject matter of any of Examples 20-27, and wherein coordinating ingestion into an ingestion framework that includes data sets in multiple formats comprises coordinating ingestion into an ingestion framework that includes unstructured data.

Example 29 includes the subject matter of any of Examples 20-28, and wherein coordinating ingestion into an ingestion framework that includes data sets in multiple formats comprises coordinating ingestion into an ingestion framework that includes semi-structured data.

Example 30 includes the subject matter of any of Examples 20-29, and wherein coordinating ingestion into an ingestion framework that includes data sets in multiple formats comprises coordinating ingestion into an ingestion framework that includes data formatted as one or more of extensible markup language, JavaScript object notation, a relational database or a flat file database.

Example 31 includes the subject matter of any of Examples 20-30, and wherein providing data from the ingestion framework to a meta model layer of the data fabric to produce metadata comprises producing a graph data structure indicative of relationships within the data.

Example 32 includes the subject matter of any of Examples 20-31, and wherein providing data from the ingestion framework to a meta model layer of the data fabric to produce metadata comprises providing the data to a data catalog of the data fabric to store, in a central repository, metadata related to the data.

Example 33 includes the subject matter of any of Examples 20-32, and wherein providing the data to a data catalog to store metadata related to the data comprises providing the data to a data catalog to store metadata indicative of one or more of data definitions, relationships, or lineage.

Example 34 includes the subject matter of any of Examples 20-33, and further including obtaining, by the compute device, a request from a target compute device for analysis of data in the data fabric; and providing, by the compute device and to the target compute device and in response to the request, data from the data fabric for analysis.

Example 35 includes the subject matter of any of Examples 20-34, and wherein obtaining a request from a target compute device for analysis comprises obtaining the request through an application programming interface call exposed by a layer of the data fabric.

Example 36 includes the subject matter of any of Examples 20-35, and wherein providing, to the target compute device, data from the data fabric for analysis comprises providing the data for visualization.

Example 37 includes the subject matter of any of Examples 20-36, and wherein providing, to the target compute device, data from the data fabric for analysis comprises providing the data in real time.

Example 38 includes the subject matter of any of Examples 20-37, and wherein providing, to the target compute device, data from the data fabric for analysis comprises to provide data indicative of transactions as the transactions occur.

Example 39 includes one or more machine-readable storage media comprising a plurality of instructions stored thereon that, in response to being executed, cause a compute device to obtain data from multiple sources; coordinate ingestion of the obtained data into an ingestion framework of a data fabric; and provide the ingested data from the ingestion framework to a meta model layer of the data fabric to produce metadata.

Example 40 includes the subject matter of Example 39, and wherein to obtain data from multiple sources comprises to obtain data from one or more streaming data sources.

Example 41 includes the subject matter of any of Examples 39 and 40, and wherein to obtain data from one or more streaming data sources comprises to obtain data indicative of transactions.

Example 42 includes the subject matter of any of Examples 39-41, and wherein to obtain data indicative of transactions comprises to obtain data indicative of financial transactions processed through one or more of multiple channels.

Example 43 includes the subject matter of any of Examples 39-42, and wherein to obtain data from multiple sources comprises to obtain data from one or more batch data sources.

Example 44 includes the subject matter of any of Examples 39-43, and wherein to obtain data from one or more batch data sources comprises to obtain data associated with customer information, financial credit score information, lending information, a data lake, or one or more functional data repositories.

Example 45 includes the subject matter of any of Examples 39-44, and wherein to coordinate ingestion comprises to coordinate ingestion into an ingestion framework that includes data sets in multiple formats.

Example 46 includes the subject matter of any of Examples 39-45, and wherein to coordinate ingestion into an ingestion framework that includes data sets in multiple formats comprises to coordinate ingestion into an ingestion framework that includes structured data.

Example 47 includes the subject matter of any of Examples 39-46, and wherein to coordinate ingestion into an ingestion framework that includes data sets in multiple formats comprises to coordinate ingestion into an ingestion framework that includes unstructured data.

Example 48 includes the subject matter of any of Examples 39-47, and wherein to coordinate ingestion into an ingestion framework that includes data sets in multiple formats comprises to coordinate ingestion into an ingestion framework that includes semi-structured data.

Example 49 includes the subject matter of any of Examples 39-48, and wherein to coordinate ingestion into an ingestion framework that includes data sets in multiple formats comprises to coordinate ingestion into an ingestion framework that includes data formatted as one or more of extensible markup language, JavaScript object notation, a relational database or a flat file database.

Example 50 includes the subject matter of any of Examples 39-49, and wherein to provide data from the ingestion framework to a meta model layer of the data fabric to produce metadata comprises to produce a graph data structure indicative of relationships within the data.

Example 51 includes the subject matter of any of Examples 39-50, and wherein to provide data from the ingestion framework to a meta model layer of the data fabric to produce metadata comprises to provide the data to a data catalog of the data fabric to store, in a central repository, metadata related to the data.

Example 52 includes the subject matter of any of Examples 39-51, and wherein to provide the data to a data catalog to store metadata related to the data comprises to provide the data to a data catalog to store metadata indicative of one or more of data definitions, relationships, or lineage.

Example 53 includes the subject matter of any of Examples 39-52, and wherein the instructions additionally cause the compute device to obtain a request from a target compute device for analysis of data in the data fabric; and provide, to the target compute device and in response to the request, data from the data fabric for analysis.

Example 54 includes the subject matter of any of Examples 39-53, and wherein to obtain a request from a target compute device for analysis comprises to obtain the request through an application programming interface call exposed by a layer of the data fabric.

Example 55 includes the subject matter of any of Examples 39-54, and wherein to provide, to the target compute device, data from the data fabric for analysis comprises to provide the data for visualization.

Example 56 includes the subject matter of any of Examples 39-55, and wherein to provide, to the target compute device, data from the data fabric for analysis comprises to provide the data in real time.

Example 57 includes the subject matter of any of Examples 39-56, and wherein to provide, to the target compute device, data from the data fabric for analysis comprises to provide data indicative of transactions as the transactions occur.

Example 58 includes a compute device comprising circuitry configured to identify an unscheduled trigger to analyze data from a data source that is communicatively coupled to a data fabric; select, from a set of models associated with the data fabric and in response to the unscheduled trigger, a corresponding model to analyze the data; and provide, in response to the unscheduled trigger, the data to the selected model for analysis.

Example 59 includes the subject matter of Example 58, and wherein to identify an unscheduled trigger comprises to identify a trigger that is not associated with a scheduled batch process for the data.

Example 60 includes the subject matter of any of Examples 58 and 59, and wherein to identify an unscheduled trigger comprises to obtain a request through an application programming interface call from a target compute device to analyze the data for visualization.

Example 61 includes the subject matter of any of Examples 58-60, and wherein to identify an unscheduled trigger comprises to obtain a request through an application programming interface call from a source compute device to analyze the data.

Example 62 includes the subject matter of any of Examples 58-61, and wherein to identify an unscheduled trigger comprises to identify that the unscheduled trigger is present in response to a determination that the data has changed.

Example 63 includes the subject matter of any of Examples 58-62, and wherein to select a corresponding model to analyze the data comprises to select the corresponding model as a function of a parameter of an obtained application programming interface call to analyze the data.

Example 64 includes the subject matter of any of Examples 58-63, and wherein to select a corresponding model to analyze the data comprises to select the corresponding model as a function of a type of analysis to be performed on the data.

Example 65 includes the subject matter of any of Examples 58-64, and wherein to select a corresponding model to analyze the data comprises to select the corresponding model as a function of an identifier of a data source associated with the data.

Example 66 includes the subject matter of any of Examples 58-65, and wherein to select a corresponding model to analyze the data comprises to select the corresponding model as a function of content of the data.

Example 67 includes the subject matter of any of Examples 58-66, and wherein to provide the data to the model for analysis comprises to provide the data to a rules-based model.

Example 68 includes the subject matter of any of Examples 58-67, and wherein to provide the data to the model for analysis comprises to provide the data to a machine learning model.

Example 69 includes the subject matter of any of Examples 58-68, and wherein to provide the data to the model for analysis comprises to provide the data an ensemble of multiple models.

Example 70 includes the subject matter of any of Examples 58-69, and wherein to provide the data to the model for analysis comprises to provide the data to a model to detect potential fraudulent activity.

Example 71 includes the subject matter of any of Examples 58-70, and wherein to provide the data to the model for analysis comprises to provide the data to a model to detect a pattern or trend in financial transactions.

Example 72 includes the subject matter of any of Examples 58-71, and wherein to provide the data to the model for analysis comprises to provide the data to a model to detect a technical anomaly.

Example 73 includes the subject matter of any of Examples 58-72, and wherein the circuitry is further configured to provide, in response to the unscheduled trigger, resultant data produced from analysis of the data using the model.

Example 74 includes the subject matter of any of Examples 58-73, and wherein to provide resultant data comprises to provide the resultant data to a target compute device.

Example 75 includes the subject matter of any of Examples 58-74, and wherein to provide the resultant data to a target compute device comprises to provide the resultant data for presentation in a user interface.

Example 76 includes the subject matter of any of Examples 58-75, and wherein to provide resultant data comprises to provide the resultant data to a data set of the data fabric for storage.

Example 77 includes the subject matter of any of Examples 58-76, and wherein to provide the resultant data to a data set of the data fabric for storage comprises to provide the resultant data to a polyglot data storage of the data fabric.

Example 78 includes the subject matter of any of Examples 58-77, and wherein to provide the resultant data to a polyglot data storage of the data fabric comprises to provide the resultant data to a polyglot data storage for storage in one or more of multiple data structures.

Example 79 includes a method comprising identifying, by a compute device, an unscheduled trigger to analyze data from a data source that is communicatively coupled to a data fabric; selecting, by the compute device and from a set of models associated with the data fabric and in response to the unscheduled trigger, a corresponding model to analyze the data; and providing, by the compute device and in response to the unscheduled trigger, the data to the selected model for analysis.

Example 80 includes the subject matter of Example 79, and wherein identifying an unscheduled trigger comprises identifying a trigger that is not associated with a scheduled batch process for the data.

Example 81 includes the subject matter of any of Examples 79 and 80, and wherein identifying an unscheduled trigger comprises obtaining a request through an application programming interface call from a target compute device to analyze the data for visualization.

Example 82 includes the subject matter of any of Examples 79-81, and wherein identifying an unscheduled trigger comprises obtaining a request through an application programming interface call from a source compute device to analyze the data.

Example 83 includes the subject matter of any of Examples 79-82, and wherein identifying an unscheduled trigger comprises identifying that the unscheduled trigger is present in response to a determination that the data has changed.

Example 84 includes the subject matter of any of Examples 79-83, and wherein selecting a corresponding model to analyze the data comprises selecting the corresponding model as a function of a parameter of an obtained application programming interface call to analyze the data.

Example 85 includes the subject matter of any of Examples 79-84, and wherein selecting a corresponding model to analyze the data comprises selecting the corresponding model as a function of a type of analysis to be performed on the data.

Example 86 includes the subject matter of any of Examples 79-85, and wherein selecting a corresponding model to analyze the data comprises selecting the corresponding model as a function of an identifier of a data source associated with the data.

Example 87 includes the subject matter of any of Examples 79-86, and wherein selecting a corresponding model to analyze the data comprises selecting the corresponding model as a function of content of the data.

Example 88 includes the subject matter of any of Examples 79-87, and wherein providing the data to the model for analysis comprises providing the data to a rules-based model.

Example 89 includes the subject matter of any of Examples 79-88, and wherein providing the data to the model for analysis comprises providing the data to a machine learning model.

Example 90 includes the subject matter of any of Examples 79-89, and wherein providing the data to the model for analysis comprises providing the data an ensemble of multiple models.

Example 91 includes the subject matter of any of Examples 79-90, and wherein providing the data to the model for analysis comprises providing the data to a model to detect potential fraudulent activity.

Example 92 includes the subject matter of any of Examples 79-91, and wherein providing the data to the model for analysis comprises providing the data to a model to detect a pattern or trend in financial transactions.

Example 93 includes the subject matter of any of Examples 79-92, and wherein providing the data to the model for analysis comprises providing the data to a model to detect a technical anomaly.

Example 94 includes the subject matter of any of Examples 79-93, and further including providing, in response to the unscheduled trigger, resultant data produced from analysis of the data using the model.

Example 95 includes the subject matter of any of Examples 79-94, and wherein providing resultant data comprises providing the resultant data to a target compute device.

Example 96 includes the subject matter of any of Examples 79-95, and wherein providing the resultant data to a target compute device comprises providing the resultant data for presentation in a user interface.

Example 97 includes the subject matter of any of Examples 79-96, and wherein providing resultant data comprises providing the resultant data to a data set of the data fabric for storage.

Example 98 includes the subject matter of any of Examples 79-97, and wherein providing the resultant data to a data set of the data fabric for storage comprises providing the resultant data to a polyglot data storage of the data fabric.

Example 99 includes the subject matter of any of Examples 79-98, and wherein providing the resultant data to a polyglot data storage of the data fabric comprises providing the resultant data to a polyglot data storage for storage in one or more of multiple data structures.

Example 100 includes one or more machine-readable storage media comprising a plurality of instructions stored thereon that, in response to being executed, cause a compute device to identify an unscheduled trigger to analyze data from a data source that is communicatively coupled to a data fabric; select, from a set of models associated with the data fabric and in response to the unscheduled trigger, a corresponding model to analyze the data; and provide, in response to the unscheduled trigger, the data to the selected model for analysis.

Example 101 includes the subject matter of Example 100, and wherein to identify an unscheduled trigger comprises to identify a trigger that is not associated with a scheduled batch process for the data.

Example 102 includes the subject matter of any of Examples 100 and 101, and wherein to identify an unscheduled trigger comprises to obtain a request through an application programming interface call from a target compute device to analyze the data for visualization.

Example 103 includes the subject matter of any of Examples 100-102, and wherein to identify an unscheduled trigger comprises to obtain a request through an application programming interface call from a source compute device to analyze the data.

Example 104 includes the subject matter of any of Examples 100-103, and wherein to identify an unscheduled trigger comprises to identify that the unscheduled trigger is present in response to a determination that the data has changed.

Example 105 includes the subject matter of any of Examples 100-104, and wherein to select a corresponding model to analyze the data comprises to select the corresponding model as a function of a parameter of an obtained application programming interface call to analyze the data.

Example 106 includes the subject matter of any of Examples 100-105, and wherein to select a corresponding model to analyze the data comprises to select the corresponding model as a function of a type of analysis to be performed on the data.

Example 107 includes the subject matter of any of Examples 100-106, and wherein to select a corresponding model to analyze the data comprises to select the corresponding model as a function of an identifier of a data source associated with the data.

Example 108 includes the subject matter of any of Examples 100-107, and wherein to select a corresponding model to analyze the data comprises to select the corresponding model as a function of content of the data.

Example 109 includes the subject matter of any of Examples 100-108, and wherein to provide the data to the model for analysis comprises to provide the data to a rules-based model.

Example 110 includes the subject matter of any of Examples 100-109, and wherein to provide the data to the model for analysis comprises to provide the data to a machine learning model.

Example 111 includes the subject matter of any of Examples 100-110, and wherein to provide the data to the model for analysis comprises to provide the data an ensemble of multiple models.

Example 112 includes the subject matter of any of Examples 100-111, and wherein to provide the data to the model for analysis comprises to provide the data to a model to detect potential fraudulent activity.

Example 113 includes the subject matter of any of Examples 100-112, and wherein to provide the data to the model for analysis comprises to provide the data to a model to detect a pattern or trend in financial transactions.

Example 114 includes the subject matter of any of Examples 100-113, and wherein to provide the data to the model for analysis comprises to provide the data to a model to detect a technical anomaly.

Example 115 includes the subject matter of any of Examples 100-114, and wherein the circuitry is further configured to provide, in response to the unscheduled trigger, resultant data produced from analysis of the data using the model.

Example 116 includes the subject matter of any of Examples 100-115, and wherein to provide resultant data comprises to provide the resultant data to a target compute device.

Example 117 includes the subject matter of any of Examples 100-116, and wherein to provide the resultant data to a target compute device comprises to provide the resultant data for presentation in a user interface.

Example 118 includes the subject matter of any of Examples 100-117, and wherein to provide resultant data comprises to provide the resultant data to a data set of the data fabric for storage.

Example 119 includes the subject matter of any of Examples 100-118, and wherein to provide the resultant data to a data set of the data fabric for storage comprises to provide the resultant data to a polyglot data storage of the data fabric.

Example 120 includes the subject matter of any of Examples 100-119, and wherein to provide the resultant data to a polyglot data storage of the data fabric comprises to provide the resultant data to a polyglot data storage for storage in one or more of multiple data structures.

Example 121 includes a compute device comprising circuitry configured to monitor utilization of data in a data fabric; determine, as a function of the monitored utilization, a candidate modification to the data fabric to reduce an inefficiency in the utilization of the data; and apply the candidate modification to reduce the inefficiency in the utilization of the data in the data fabric.

Example 122 includes the subject matter of Example 121, and wherein to monitor utilization of data in a data fabric comprises to identify one or more data utilization patterns.

Example 123 includes the subject matter of any of Examples 121 and 122, and wherein to identify one or more data utilization patterns comprises to determine a frequency of requests to access data.

Example 124 includes the subject matter of any of Examples 121-123, and wherein to determine a frequency of requests comprises to determine a frequency of requests per type of data.

Example 125 includes the subject matter of any of Examples 121-124, and wherein to determine a frequency of requests comprises to determine a frequency of requests for analysis of the data.

Example 126 includes the subject matter of any of Examples 121-125, and wherein to determine a frequency of requests for analysis of data comprises to determine a frequency of requests for each of multiple types of analysis of the data.

Example 127 includes the subject matter of any of Examples 121-126, and wherein to monitor utilization of data in a data fabric comprises to determine a frequency of updates to the data.

Example 128 includes the subject matter of any of Examples 121-127, and wherein to monitor utilization of data in a data fabric comprises to determine time periods between requests and completions of requests.

Example 129 includes the subject matter of any of Examples 121-128, and wherein the circuitry is further configured to identify, as inefficiencies, time periods satisfying a predefined threshold time period.

Example 130 includes the subject matter of any of Examples 121-129, and wherein to determine, as a function of the monitored utilization, a candidate modification comprises to determine a modification to change a target data set for the data as a function of a frequency of utilization of the data.

Example 131 includes the subject matter of any of Examples 121-130, and wherein to determine a modification to change a target data set comprises to determine a modification change to a target data set having a faster response time than another target data set.

Example 132 includes the subject matter of any of Examples 121-131, and wherein to determine the modification to change to a target data set comprises to determine the modification as a function of a structure of the target data set.

Example 133 includes the subject matter of any of Examples 121-132, and wherein to determine, as a function of the monitored utilization, a candidate modification comprises to determine a modification to convert a batch data source to a stream data source to reduce latency in obtaining data.

Example 134 includes the subject matter of any of Examples 121-133, and wherein to determine, as a function of the monitored utilization, a candidate modification comprises to determine a modification to proactively provide data to a model for analysis in response to a determination that the data has changed, to provide resultant data before the resultant data is requested.

Example 135 includes the subject matter of any of Examples 121-134, and wherein to determine, as a function of the monitored utilization, a candidate modification comprises to determine to remove one or more data preprocessing operations that produce resultant data that is not accessed at a defined threshold frequency.

Example 136 includes the subject matter of any of Examples 121-135, and wherein to remove one or more data preprocessing operations comprises to remove one or more data formatting or summarization operations.

Example 137 includes the subject matter of any of Examples 121-136, and wherein to apply the candidate modification comprise to implement the modification programmatically.

Example 138 includes the subject matter of any of Examples 121-137, and wherein to implement the modification programmatically comprises to implement the modification through on or more application programming interface calls.

Example 139 includes the subject matter of any of Examples 121-138, and wherein to implement the modification programmatically comprises to implement the modification through changes to configuration data utilized by the data fabric.

Example 140 includes the subject matter of any of Examples 121-139, and wherein to apply the candidate modification comprises to present data indicative of the candidate modification for review.

Example 141 includes a method comprising monitoring, by a compute device, utilization of data in a data fabric; determining, by the compute device and as a function of the monitored utilization, a candidate modification to the data fabric to reduce an inefficiency in the utilization of the data; and applying, by the compute device, the candidate modification to reduce the inefficiency in the utilization of the data in the data fabric.

Example 142 includes the subject matter of Example 141, and wherein monitoring utilization of data in a data fabric comprises identifying one or more data utilization patterns.

Example 143 includes the subject matter of any of Examples 141 and 142, and wherein identifying one or more data utilization patterns comprises determining a frequency of requests to access data.

Example 144 includes the subject matter of any of Examples 141-143, and wherein determining a frequency of requests comprises determining a frequency of requests per type of data.

Example 145 includes the subject matter of any of Examples 141-144, and wherein determining a frequency of requests comprises determining a frequency of requests for analysis of the data.

Example 146 includes the subject matter of any of Examples 141-145, and wherein determining a frequency of requests for analysis of data comprises determining a frequency of requests for each of multiple types of analysis of the data.

Example 147 includes the subject matter of any of Examples 141-146, and wherein monitoring utilization of data in a data fabric comprises determining a frequency of updates to the data.

Example 148 includes the subject matter of any of Examples 141-147, and wherein monitoring utilization of data in a data fabric comprises determining time periods between requests and completions of requests.

Example 149 includes the subject matter of any of Examples 141-148, and further including identifying, by the compute device and as inefficiencies, time periods satisfying a predefined threshold time period.

Example 150 includes the subject matter of any of Examples 141-149, and wherein determining, as a function of the monitored utilization, a candidate modification comprises to determine a modification to change a target data set for the data as a function of a frequency of utilization of the data.

Example 151 includes the subject matter of any of Examples 141-150, and wherein determining a modification to change a target data set comprises determining a modification change to a target data set having a faster response time than another target data set.

Example 152 includes the subject matter of any of Examples 141-151, and wherein determining the modification to change to a target data set comprises determining the modification as a function of a structure of the target data set.

Example 153 includes the subject matter of any of Examples 141-152, and wherein determining, as a function of the monitored utilization, a candidate modification comprises determining a modification to convert a batch data source to a stream data source to reduce latency in obtaining data.

Example 154 includes the subject matter of any of Examples 141-153, and wherein determining, as a function of the monitored utilization, a candidate modification comprises determining a modification to proactively provide data to a model for analysis in response to a determination that the data has changed, to provide resultant data before the resultant data is requested.

Example 155 includes the subject matter of any of Examples 141-154, and wherein determining, as a function of the monitored utilization, a candidate modification comprises determining to remove one or more data preprocessing operations that produce resultant data that is not accessed at a defined threshold frequency.

Example 156 includes the subject matter of any of Examples 141-155, and wherein removing one or more data preprocessing operations comprises removing one or more data formatting or summarization operations.

Example 157 includes the subject matter of any of Examples 141-156, and wherein applying the candidate modification comprises implementing the modification programmatically.

Example 158 includes the subject matter of any of Examples 141-157, and wherein implementing the modification programmatically comprises implementing the modification through on or more application programming interface calls.

Example 159 includes the subject matter of any of Examples 141-158, and wherein implementing the modification programmatically comprises implementing the modification through changes to configuration data utilized by the data fabric.

Example 160 includes the subject matter of any of Examples 141-159, and wherein applying the candidate modification comprises presenting data indicative of the candidate modification for review.

Example 161 includes one or more machine-readable storage media comprising a plurality of instructions stored thereon that, in response to being executed, cause a compute device to monitor utilization of data in a data fabric; determine, as a function of the monitored utilization, a candidate modification to the data fabric to reduce an inefficiency in the utilization of the data; and apply the candidate modification to reduce the inefficiency in the utilization of the data in the data fabric.

Example 162 includes the subject matter of Example 161, and wherein to monitor utilization of data in a data fabric comprises to identify one or more data utilization patterns.

Example 163 includes the subject matter of any of Examples 161 and 162, and wherein to identify one or more data utilization patterns comprises to determine a frequency of requests to access data.

Example 164 includes the subject matter of any of Examples 161-163, and wherein to determine a frequency of requests comprises to determine a frequency of requests per type of data.

Example 165 includes the subject matter of any of Examples 161-164, and wherein to determine a frequency of requests comprises to determine a frequency of requests for analysis of the data.

Example 166 includes the subject matter of any of Examples 161-165, and wherein to determine a frequency of requests for analysis of data comprises to determine a frequency of requests for each of multiple types of analysis of the data.

Example 167 includes the subject matter of any of Examples 161-166, and wherein to monitor utilization of data in a data fabric comprises to determine a frequency of updates to the data.

Example 168 includes the subject matter of any of Examples 161-167, and wherein to monitor utilization of data in a data fabric comprises to determine time periods between requests and completions of requests.

Example 169 includes the subject matter of any of Examples 161-168, and wherein the instructions additionally cause the compute device to identify, as inefficiencies, time periods satisfying a predefined threshold time period.

Example 170 includes the subject matter of any of Examples 161-169, and wherein to determine, as a function of the monitored utilization, a candidate modification comprises to determine a modification to change a target data set for the data as a function of a frequency of utilization of the data.

Example 171 includes the subject matter of any of Examples 161-170, and wherein to determine a modification to change a target data set comprises to determine a modification change to a target data set having a faster response time than another target data set.

Example 172 includes the subject matter of any of Examples 161-171, and wherein to determine the modification to change to a target data set comprises to determine the modification as a function of a structure of the target data set.

Example 173 includes the subject matter of any of Examples 161-172, and wherein to determine, as a function of the monitored utilization, a candidate modification comprises to determine a modification to convert a batch data source to a stream data source to reduce latency in obtaining data.

Example 174 includes the subject matter of any of Examples 161-173, and wherein to determine, as a function of the monitored utilization, a candidate modification comprises to determine a modification to proactively provide data to a model for analysis in response to a determination that the data has changed, to provide resultant data before the resultant data is requested.

Example 175 includes the subject matter of any of Examples 161-174, and wherein to determine, as a function of the monitored utilization, a candidate modification comprises to determine to remove one or more data preprocessing operations that produce resultant data that is not accessed at a defined threshold frequency.

Example 176 includes the subject matter of any of Examples 161-175, and wherein to remove one or more data preprocessing operations comprises to remove one or more data formatting or summarization operations.

Example 177 includes the subject matter of any of Examples 161-176, and wherein to apply the candidate modification comprise to implement the modification programmatically.

Example 178 includes the subject matter of any of Examples 161-177, and wherein to implement the modification programmatically comprises to implement the modification through on or more application programming interface calls.

Example 179 includes the subject matter of any of Examples 161-178, and wherein to implement the modification programmatically comprises to implement the modification through changes to configuration data utilized by the data fabric.

Example 180 includes the subject matter of any of Examples 161-179, and wherein to apply the candidate modification comprises to present data indicative of the candidate modification for review.

Example 181 includes a compute device comprising circuitry configured to obtain configuration data indicative of a set of operations to be performed to ingest data into a data fabric; and execute, as a function of the obtained configuration data, the set of data ingestion operations.

Example 182 includes the subject matter of Example 181, and wherein to obtain configuration data comprises to read configuration data from a configuration file.

Example 183 includes the subject matter of any of Examples 181 and 182, and wherein to obtain configuration data comprises to read configuration data transmitted from a compute device.

Example 184 includes the subject matter of any of Examples 181-183, and wherein to obtain configuration data comprises to read configuration data written through execution of a data utilization enhancement process.

Example 185 includes the subject matter of any of Examples 181-184, and wherein to execute the set of data ingestion operations comprises to read input data from a data source defined in the obtained configuration data.

Example 186 includes the subject matter of any of Examples 181-185, and wherein to read input data from a data source defined in the obtained configuration data comprises to read input data according to a schedule defined in the configuration data.

Example 187 includes the subject matter of any of Examples 181-186, and wherein to read input data comprises to read one or more subsets of available input data as defined in the configuration data.

Example 188 includes the subject matter of any of Examples 181-187, and wherein to read one or more subsets comprises to read one or more defined fields, columns, rows, records or properties that satisfy a set of one or more parameters defined in the configuration data.

Example 189 includes the subject matter of any of Examples 181-188, and wherein to read input data comprises to parse the input data according to a format or schema defined in the configuration data.

Example 190 includes the subject matter of any of Examples 181-189, and wherein read input data comprises to communicate with the defined data source according to one or more parameters defined in the configuration data.

Example 191 includes the subject matter of any of Examples 181-190, and wherein to communicate with the defined data source according to one or more parameters defined in the configuration data comprises to communicate according to a network address, a port, a protocol, or an application programming interface defined in the configuration data.

Example 192 includes the subject matter of any of Examples 181-191, and wherein to execute the set of data ingestion operations comprises to route input data to a target data set defined in the configuration data.

Example 193 includes the subject matter of any of Examples 181-192, and wherein to execute the set of data ingestion operations comprises to perform preprocessing or reformatting operations identified in the configuration data.

Example 194 includes the subject matter of any of Examples 181-193, and wherein to execute the set of data ingestion operations comprises to produce a set of metadata as defined in the configuration data.

Example 195 includes the subject matter of any of Examples 181-194, and wherein to execute the set of data ingestion operations comprises to produce metadata indicative of relationships between identified data types.

Example 196 includes the subject matter of any of Examples 181-195, and wherein to execute the set of data ingestion operations comprises to produce a graph data structure associated with the set of metadata.

Example 197 includes the subject matter of any of Examples 181-196, and wherein to execute the set of data ingestion operations comprises to provide data identified in the configuration data to a model identified in the configuration data to produce resultant data.

Example 198 includes the subject matter of any of Examples 181-197, and wherein the configuration data is first set of configuration data obtained at a first time, and the circuitry is further configured to obtain, at a second time, a second set of configuration data indicative of operations to be performed to ingest data into the data fabric; and execute the operations indicated in the second set of configuration data to ingest data into the data fabric.

Example 199 includes a method comprising obtaining, by a compute device, configuration data indicative of a set of operations to be performed to ingest data into a data fabric; and executing, by the compute device and as a function of the obtained configuration data, the set of data ingestion operations.

Example 200 includes the subject matter of Example 199, and wherein obtaining configuration data comprises reading configuration data from a configuration file.

Example 201 includes the subject matter of any of Examples 199 and 200, and wherein obtaining configuration data comprises reading configuration data transmitted from a compute device.

Example 202 includes the subject matter of any of Examples 199-201, and wherein obtaining configuration data comprises reading configuration data written through execution of a data utilization enhancement process.

Example 203 includes the subject matter of any of Examples 199-202, and wherein executing the set of data ingestion operations comprises reading input data from a data source defined in the obtained configuration data.

Example 204 includes the subject matter of any of Examples 199-203, and wherein reading input data from a data source defined in the obtained configuration data comprises reading input data according to a schedule defined in the configuration data.

Example 205 includes the subject matter of any of Examples 199-204, and wherein reading input data comprises reading one or more subsets of available input data as defined in the configuration data.

Example 206 includes the subject matter of any of Examples 199-205, and wherein reading one or more subsets comprises reading one or more defined fields, columns, rows, records or properties that satisfy a set of one or more parameters defined in the configuration data.

Example 207 includes the subject matter of any of Examples 199-206, and wherein reading input data comprises parsing the input data according to a format or schema defined in the configuration data.

Example 208 includes the subject matter of any of Examples 199-207, and wherein reading input data comprises communicating with the defined data source according to one or more parameters defined in the configuration data.

Example 209 includes the subject matter of any of Examples 199-208, and wherein communicating with the defined data source according to one or more parameters defined in the configuration data comprises communicating according to a network address, a port, a protocol, or an application programming interface defined in the configuration data.

Example 210 includes the subject matter of any of Examples 199-209, and wherein executing the set of data ingestion operations comprises routing input data to a target data set defined in the configuration data.

Example 211 includes the subject matter of any of Examples 199-210, and wherein executing the set of data ingestion operations comprises performing preprocessing or reformatting operations identified in the configuration data.

Example 212 includes the subject matter of any of Examples 199-211, and wherein executing the set of data ingestion operations comprises producing a set of metadata as defined in the configuration data.

Example 213 includes the subject matter of any of Examples 199-212, and wherein executing the set of data ingestion operations comprises producing metadata indicative of relationships between identified data types.

Example 214 includes the subject matter of any of Examples 199-213, and wherein executing the set of data ingestion operations comprises producing a graph data structure associated with the set of metadata.

Example 215 includes the subject matter of any of Examples 199-214, and wherein executing the set of data ingestion operations comprises providing data identified in the configuration data to a model identified in the configuration data to produce resultant data.

Example 216 includes the subject matter of any of Examples 199-215, and wherein the configuration data is first set of configuration data obtained at a first time, and the method further comprises obtaining, by the compute device and at a second time, a second set of configuration data indicative of operations to be performed to ingest data into the data fabric; and executing, by the compute device, the operations indicated in the second set of configuration data to ingest data into the data fabric.

Example 217 includes one or more machine-readable storage media comprising a plurality of instructions stored thereon that, in response to being executed, cause a compute device to obtain configuration data indicative of a set of operations to be performed to ingest data into a data fabric; and execute, as a function of the obtained configuration data, the set of data ingestion operations.

Example 218 includes the subject matter of Example 217, and wherein to obtain configuration data comprises to read configuration data from a configuration file.

Example 219 includes the subject matter of any of Examples 217 and 218, and wherein to obtain configuration data comprises to read configuration data transmitted from a compute device.

Example 220 includes the subject matter of any of Examples 217-219, and wherein to obtain configuration data comprises to read configuration data written through execution of a data utilization enhancement process.

Example 221 includes the subject matter of any of Examples 217-220, and wherein to execute the set of data ingestion operations comprises to read input data from a data source defined in the obtained configuration data.

Example 222 includes the subject matter of any of Examples 217-221, and wherein to read input data from a data source defined in the obtained configuration data comprises to read input data according to a schedule defined in the configuration data.

Example 223 includes the subject matter of any of Examples 217-222, and wherein to read input data comprises to read one or more subsets of available input data as defined in the configuration data.

Example 224 includes the subject matter of any of Examples 217-223, and wherein to read one or more subsets comprises to read one or more defined fields, columns, rows, records or properties that satisfy a set of one or more parameters defined in the configuration data.

Example 225 includes the subject matter of any of Examples 217-224, and wherein to read input data comprises to parse the input data according to a format or schema defined in the configuration data.

Example 226 includes the subject matter of any of Examples 217-225, and wherein to read input data comprises to communicate with the defined data source according to one or more parameters defined in the configuration data.

Example 227 includes the subject matter of any of Examples 217-226, and wherein to communicate with the defined data source according to one or more parameters defined in the configuration data comprises to communicate according to a network address, a port, a protocol, or an application programming interface defined in the configuration data.

Example 228 includes the subject matter of any of Examples 217-227, and wherein to execute the set of data ingestion operations comprises to route input data to a target data set defined in the configuration data.

Example 229 includes the subject matter of any of Examples 217-228, and wherein to execute the set of data ingestion operations comprises to perform preprocessing or reformatting operations identified in the configuration data.

Example 230 includes the subject matter of any of Examples 217-229, and wherein to execute the set of data ingestion operations comprises to produce a set of metadata as defined in the configuration data.

Example 231 includes the subject matter of any of Examples 217-230, and wherein to execute the set of data ingestion operations comprises to produce metadata indicative of relationships between identified data types.

Example 232 includes the subject matter of any of Examples 217-231, and wherein to execute the set of data ingestion operations comprises to produce a graph data structure associated with the set of metadata.

Example 233 includes the subject matter of any of Examples 217-232, and wherein to execute the set of data ingestion operations comprises to provide data identified in the configuration data to a model identified in the configuration data to produce resultant data.

Example 234 includes the subject matter of any of Examples 217-233, and wherein the configuration data is first set of configuration data obtained at a first time, and the instructions additionally cause the compute device to obtain, at a second time, a second set of configuration data indicative of operations to be performed to ingest data into the data fabric; and execute the operations indicated in the second set of configuration data to ingest data into the data fabric.

1. A compute device comprising:
circuitry configured to:
obtain data from multiple sources;
coordinate ingestion of the obtained data into an ingestion framework of a data fabric; and
provide the ingested data from the ingestion framework to a meta model layer of the data fabric to produce metadata.

2. The compute device of claim 1, wherein to coordinate ingestion comprises to coordinate ingestion into an ingestion framework that includes data sets in multiple formats.

3. The compute device of claim 2, wherein to coordinate ingestion into an ingestion framework that includes data sets in multiple formats comprises to coordinate ingestion into an ingestion framework that includes structured data, unstructured data, semi-structured data.

4. The compute device of claim 2, wherein to coordinate ingestion into an ingestion framework that includes data sets in multiple formats comprises to coordinate ingestion into an ingestion framework that includes data formatted as one or more of extensible markup language, JavaScript object notation, a relational database or a flat file database.

5. The compute device of claim 1, wherein to provide data from the ingestion framework to a meta model layer of the data fabric to produce metadata comprises to produce a graph data structure indicative of relationships within the data.

6. The compute device of claim 1, wherein to provide data from the ingestion framework to a meta model layer of the data fabric to produce metadata comprises to provide the data to a data catalog of the data fabric to store, in a central repository, metadata related to the data.

7. The compute device of claim 6, wherein to provide the data to a data catalog to store metadata related to the data comprises to provide the data to a data catalog to store metadata indicative of one or more of data definitions, relationships, or lineage.

8. The compute device of claim 1, wherein the circuitry is further configured to:
obtain a request from a target compute device for analysis of data in the data fabric; and
provide, to the target compute device and in response to the request, data from the data fabric for analysis.

9. The compute device of claim 8, wherein to obtain a request from a target compute device for analysis comprises to obtain the request through an application programming interface call exposed by a layer of the data fabric.

10. The compute device of claim 8, wherein to provide, to the target compute device, data from the data fabric for analysis comprises to provide data indicative of transactions as the transactions occur.

11. A compute device comprising:
circuitry configured to:
identify an unscheduled trigger to analyze data from a data source that is communicatively coupled to a data fabric;
select, from a set of models associated with the data fabric and in response to the unscheduled trigger, a corresponding model to analyze the data; and
provide, in response to the unscheduled trigger, the data to the selected model for analysis.

12. The compute device of claim 11, wherein to identify an unscheduled trigger comprises to identify a trigger that is not associated with a scheduled batch process for the data.

13. The compute device of claim 11, wherein to identify an unscheduled trigger comprises to obtain a request through an application programming interface call from a target compute device to analyze the data for visualization.

14. The compute device of claim 11, wherein to identify an unscheduled trigger comprises to obtain a request through an application programming interface call from a source compute device to analyze the data.

15. The compute device of claim 11, wherein to identify an unscheduled trigger comprises to identify that the unscheduled trigger is present in response to a determination that the data has changed.

16. The compute device of claim 11, wherein to select a corresponding model to analyze the data comprises to select the corresponding model as a function of a parameter of an obtained application programming interface call to analyze the data.

17. The compute device of claim 16, wherein to select a corresponding model to analyze the data comprises to select the corresponding model as a function of a type of analysis to be performed on the data.

18. The compute device of claim 11, wherein to select a corresponding model to analyze the data comprises to select the corresponding model as a function of an identifier of a data source associated with the data.

19. The compute device of claim 11, wherein to select a corresponding model to analyze the data comprises to select the corresponding model as a function of content of the data.

20. The compute device of claim 11, wherein to provide the data to the model for analysis comprises to provide the data to a model to detect potential fraudulent activity.

21. The compute device of claim 11, wherein to provide the data to the model for analysis comprises to provide the data to a model to detect a pattern or trend in financial transactions.

22. The compute device of claim 11, wherein to provide the data to the model for analysis comprises to provide the data to a model to detect a technical anomaly.

23. The compute device of claim 11, wherein the circuitry is further configured to provide, in response to the unscheduled trigger, resultant data produced from analysis of the data using the model.

24. The compute device of claim 23, wherein to provide resultant data comprises to provide the resultant data to a target compute device.

25. The compute device of claim 24, wherein to provide the resultant data to a target compute device comprises to provide the resultant data for presentation in a user interface.

26. The compute device of claim 24, wherein to provide resultant data comprises to provide the resultant data to a data set of the data fabric for storage, wherein to provide the resultant data to a data set of the data fabric for storage comprises to provide the resultant data to a polyglot data storage of the data fabric.

27. A compute device comprising:
circuitry configured to:
monitor utilization of data in a data fabric;
determine, as a function of the monitored utilization, a candidate modification to the data fabric to reduce an inefficiency in the utilization of the data; and
apply the candidate modification to reduce the inefficiency in the utilization of the data in the data fabric.

28. The compute device of claim 27, wherein to monitor utilization of data in a data fabric comprises to identify one or more data utilization patterns by determining (i) a frequency of requests to access data; (ii) a frequency of requests for analysis of the data; and/or (iii) a frequency of requests for each of multiple types of analysis of the data.

29. The compute device of claim 27, wherein to monitor utilization of data in a data fabric comprises to determine: (i) a frequency of updates to the data; (ii) time periods between requests and completions of requests.

30. The compute device of claim 27, wherein the circuitry is further configured to identify, as inefficiencies, time periods satisfying a predefined threshold time period.

31. The compute device of claim 27, wherein to determine, as a function of the monitored utilization, a candidate modification comprises to determine a modification to change a target data set for the data as a function of a frequency of utilization of the data.

32. The compute device of claim 27, wherein to determine a modification to change to a target data set comprises to determine a modification as a function of a structure of the target data set.

33. The compute device of claim 27, wherein to determine, as a function of the monitored utilization, a candidate modification comprises to determine a modification to convert a batch data source to a stream data source to reduce latency in obtaining data.

34. The compute device of claim 27, wherein to determine, as a function of the monitored utilization, a candidate modification comprises to determine a modification to proactively provide data to a model for analysis in response to a determination that the data has changed, to provide resultant data before the resultant data is requested.

35. The compute device of claim 27, wherein to determine, as a function of the monitored utilization, a candidate modification comprises to determine to remove one or more data preprocessing operations that produce resultant data that is not accessed at a defined threshold frequency.

36. The compute device of claim 35, wherein to remove one or more data preprocessing operations comprises to remove one or more data formatting or summarization operations.

37. The compute device of claim 27, wherein to apply the candidate modification comprise to implement the modification programmatically, wherein to implement the modification programmatically comprises to implement the modification through (i) one or more application programming interface calls; and/or (ii) changes to configuration data utilized by the data fabric.

38. The compute device of claim 27, wherein to apply the candidate modification comprises to present data indicative of the candidate modification for review.
